(19) United States
(12) Patent Application Publication
(10) Pub. No.: US 2024/0206425 A1
(43) Pub. Date: Jun. 27, 2024

(54) ANIMAL HABITAT

(71) Applicant: Vistagato, LLC, Corona, CA (US)

(72) Inventors: Aurelio Barreto, Corona, CA (US); Kevin Kolozsvari, Dana Point, CA (US)

(21) Appl. No.: 18/395,344

(22) Filed: Dec. 22, 2023

Related U.S. Application Data
(60) Provisional application No. 63/477,369, filed on Dec. 27, 2022.
(60) Provisional application No. 63/493,679, filed on Mar. 31, 2023.

(51) Int. Cl. A01K 1/03

(52) U.S. Cl. CPC A01K 1/033

(57) ABSTRACT

A habitat for an animal may include a housing which can include a bottom portion, a first side portion, a second side portion, an upper portion, and a back portion. The housing can also have a space bounded at least by the bottom portion, the first side portion, the second side portion, and the upper portion. The housing can also have an opening in communication with the space within the housing. The habitat can include a front cover operably coupled with the housing. The housing can also include a door configured to move between an open position and a closed position relative to the opening. The habitat can include a ledge. A habitat can also include a clamp having a knob configured to be rotated in a first direction to operatively close the clamp to secure the habitat in the window opening.

### PRIORITY CLAIM AND INCORPORATION BY REFERENCE

The present application claims priority from U.S. Patent Application No. 63/477,369 filed on Dec. 27, 2022, titled ANIMAL HABITAT; and U.S. Patent Application No. 63/493,679 filed on Mar. 31, 2023, titled ANIMAL HABITAT, the contents of each of which is hereby incorporated by reference herein in its entirety as if fully set forth herein. The benefit of priority is claimed under the appropriate legal basis including, without limitation, under 35 U.S.C. § 119(e). Any and all applications for which a foreign or domestic priority claim is identified in the Application Data Sheet as filed with the present application are hereby incorporated by reference herein in their entirety and made a part of this specification.

### BACKGROUND

### Field

The present application relates to animal habitats, and more particularly, animal habitats configured to be positioned in a window opening.

### Description of Related Art

Many households across the world have pets and notably, in the United States, approximately 70% of households have a pet or domestic animal. These animals provide companionship, friendship, and affection to their owners and in response the owners may feel a greater sense of responsibility, self-worth, and overall happiness. Due to this relationship between owner and pet, many pet owners purchase myriad items or accessories for their pet so that their pet is happy and entertained.

Many pets desire being outside or being exposed to the outdoors. However, not all of these animals live in homes or apartments which permit such exposure. In addition, certain weather conditions might make it untenable or dangerous for these pets to go outside since the cold, wind, or rain might leave the animals stranded and lost until the conditions subside.

Occasionally, homeowners or apartment renters have a porch or ledge which they may leave their pet on so that the pet may go outside without leaving the confines of a building. Others may have a patio or fenced-in area that permits the pet to roam outdoors, without fear that the pet may stray too far or become difficult to find if the owner has to leave the home or if weather conditions change. However, certain pets do not function as well in fenced-in areas or porches and will still tend to stray from the area and will only return when they decide or when the conditions permit.

Many pet owners have cats, which are the second most popular pet in the United States. They provide comfort and companionship similar to other pets, yet these animals may tend to stray or do not remain in confined spaces to the same level as a dog or other domestic animal. Conversely, cats may also tend to stay inside and may not get enough exposure to the outdoors. These cats may need additional support or accessories to support their lifestyle. For example, many cat owners will purchase cat accessories which may allow the cat to experience the outdoors.

As functional as these other accessories are, there are a few drawbacks. For example, if the cat or pet is not an animal that enjoys being outdoors, then the animal will not be exposed to a natural environment. Additionally, since a cat wall shelf, for example, will limit the cat to resting or perching on an elevated surface within the house, the cat will not be exposed to much natural sunlight or air.

### SUMMARY OF SOME EXEMPLIFYING EMBODIMENTS

Disclosed herein are some exemplifying embodiments of a habitat for an animal. Some embodiments of the habit can be configured to provide an outdoor experience for a cat or other animal within the safe confines of an enclosure configured to prevent the animal from escaping from the habitat and preventing other animals, insects, or creatures from entering into the habitat. Many cats love the outdoors and thrive when their senses are engaged and satisfied by the natural, outdoor world. Embodiments of the habitat disclosed herein provide that experience for cats and/or other animals.

Some embodiments of the novel animal habitat for positioning in a window disclosed herein include a housing that can have a bottom portion, a first side portion coupled with the bottom portion, a second side portion coupled with the bottom portion, an upper portion coupled with the first side portion and the second side portion, a back portion coupled with the bottom portion, the first side portion, and the second side portion, and an opening in communication with the space within the housing. The housing can further include a space within the housing which can be bounded at least by the bottom portion, the first side portion, the second side portion, and the upper portion. The housing can also include and an opening in communication with the space within the housing. The habitat can include a front cover which can be configured to be coupled with the housing and to cover the opening in the housing when the front cover is coupled with the housing. The front cover can include an opening which can be sized and configured to permit an animal to pass through and into the space within the housing when the front cover is operably coupled with the housing. The front cover can also include a door which can be configured to move between an open position and a closed position relative to the opening. The habitat can also include a ledge extending outward away from the front cover below the opening in the front cover. The ledge can be sized and configured to permit an animal to be supported by the ledge outside of the space within the housing. Furthermore, and in some embodiments, the habitat can include a clamp. The clamp can be configured to engage with a portion of a window frame surrounding the window opening or to a window configured to slide relative to the window frame. Additionally, the clamp can have a knob positioned on a front portion of the housing. The knob can be configured to be rotated in a first direction or first path to close the clamp to secure the habitat in the window opening. The knob can also be configured to be rotated in a second direction or second path to open a clamp to release the habitat from the window opening. In some embodiments, the opening in the housing can extend entirely across a front of the housing and the front cover is configured to extend across the entire opening in the housing when the front cover is coupled with the housing. The clamp can translate on one or more rails. The habitat can also include a litter box.

In some embodiments disclosed herein, the front cover can be configured to extend across the housing from the first side portion to the second side portion and from the bottom portion to the upper portion. In some embodiments, the habitat can include engagement features configured to operably secure the front cover to the housing, the engagement features configured to allow the front cover to be removed from the housing. The engagement features can be configured to operably secure the front cover to the housing and can to allow the front cover to be removed from the housing without using any tools. Additionally, the engagement features of the front cover can provide a snap fit with the housing. Furthermore, and in some embodiments, the engagement features of the front cover can include fasteners configured to removably secure the front cover to the housing. Additionally, the engagement features of the front cover can permit the front cover to slide onto the housing.

In some embodiments disclosed herein, the habitat can include a front cover which can be configured to be separated from the housing. The habitat when separated from the housing can allow air to flow through the housing, through the space within the housing, and through the opening in the housing to permit air to flow through a window that the habitat is positioned within. Additionally, the habitat can be configured such that, when the front cover is operably coupled with the housing, the habitat can prohibit air to flow by restricting air from entering through the housing, through the space within the housing, and through the opening in the housing to prohibit air to low through a window that the habitat is positioned within. In some embodiments, the front cover can be opaque or transparent. The front cover can be composed of Polyethylene, Polypropylene, or Polyethylene Terephthalate. The front cover can also be modular.

In some embodiments, the habitat can include a grasping element which can be configured to permit a user to lift at least the front cover with one or both hands by engaging the grasping element with one or both hands. The grasping element can be located at the top or at a top portion of the front cover. The grasping element can be configured to permit a user to lift at least the front cover with one or both hands by engaging the grasping element with one or both hands. The grasping element can include a handle and can include a recess configured to receive at least the fingers of a user. In some embodiments disclosed herein, the grasping element can be monolithically formed with the front cover. The grasping element can also be formed separately from the front cover and is coupled with the front cover.

In some embodiments disclosed herein, the door can be configured to rotate relative to the opening in the front cover between the open position and the closed position. The door can be biased to the closed position. Additionally, the door can be biased to the closed position using one or more pairs of magnets. The door can be biased to the closed position using at least one magnet coupled with the housing or the door and at least one ferrous element or magnet coupled with the other of the housing and the door. The door on the front cover can open via a hinge located on the upper portion of the door. The door on the front cover can include a ferrous element or a magnet coupled with the door. The door on the front cover can also include a ferrous element or a magnet positioned in the middle of the door. Furthermore, in some embodiments, the door on the front cover can include a ferrous element or a positioned inferior to the door to bias the door to the closed position. The door on the front cover can be transparent or opaque.

In some embodiments disclosed herein, the habitat can include a wireless communication element and a latch configured to selectively secure the door in the closed position upon receiving an input from a user. The wireless communication element can be configured to open the door remotely upon receiving an input from a user. Additionally, the habitat can be configured to permit a user to secure the door in a latched position via a wireless communication element. The wireless communication element can be configured to receive instructions wirelessly from a user.

In some embodiments disclosed herein, the ledge can be coupled with the front cover. The ledge can extend away from a front surface of the front cover at an angle that is orthogonal to the front surface of the front cover. The ledge can also include a smooth upper surface. Alternatively, and in some embodiments, the ledge can include a textured upper surface including raised domes, bumps, etching, abrasions, grass, or artificial turf. The ledge can be made of Polyethylene, Polypropylene, or Polyethylene Terephthalate. Furthermore, the ledge can be removable from the front cover without the use of tools. The ledge can include a magnet or ferrous component positioned below a bottom edge of the door when the door is in the closed position to bias the door in the closed position.

In some embodiments disclosed herein, the housing can be monolithically formed such that the bottom portion, the first side portion, the second side portion, the upper portion, and the back portion can be formed as a single component. In some embodiments, the bottom portion of the housing is untextured. Additionally, the bottom portion of the housing can be textured with carpet, domes, grass, artificial turf, or raised bumps. The housing can be made from Polyethylene, Polypropylene, or Polyethylene Terephthalate. In some embodiments, the housing can include a grasping element which can be monolithically formed with the housing. Additionally, the grasping element on the housing can be formed separately from the housing and is fastened to the housing.

Some embodiments of the habitat disclosed herein includes a back portion which is solid and does not have any openings configured to permit air to pass therethrough. Alternatively, in other embodiments, the back portion of the housing or at least openings in any portion of the housing can be covered with a mesh material. In any embodiments, the back portion of the housing can have openings or slots. For example and without limitation, the back portion of the housing can have openings or slots 25%, 50%, or 75% or less of the total area of the back portion.

In some embodiments of the habitat disclosed herein, the back portion of the housing can have a plurality of slots with a mesh covering. Alternatively, other embodiments can include a back portion wherein the back portion of the housing can have a plurality of slots, in any combination: (a) that extend in a vertical direction when the housing is in an operable position, wherein the plurality of slots do not extend completely to the bottom portion; (b) wherein the plurality of slots have a height in the vertical direction that is less than or equal to 70%, 80%, or 90% of a total height of the back portion in a vertical direction; (c) wherein the plurality of slots are spaced apart from a bottom edge of the back portion by a distance that is at least 2%, 5%, 10%, 15% of a total height of the back portion in a vertical direction; (d) wherein a height of the plurality of slots of the back portion is at least 25%, 50%, or 75% of a total height of the back portion; (e) wherein each of the plurality of slots has a width that less than 5%, 10%, 20%, 25%, or 30% of a width of the back panel; (f) wherein the plurality of slots are equidistantly spaced apart; and (g) wherein the plurality of slots are not equidistantly spaced apart.

Some embodiments of the habitat disclosed herein include an upper portion that may be sloped to bias water to drain from the upper portion or where the upper portion of the housing is textured.

Some embodiments of the habitat disclosed herein include a first sealing panel and a second sealing panel that extend laterally away from the housing in a first direction and a second direction, respectively, wherein the second direction is opposite to the first direction. The first and second sealing panels can be configured to extend laterally to fill some or all of the open space between an outside of the housing and a window frame or opening to prevent any open air space in the window around the habitat and/or to reduce air gaps around the housing of the habitat. In some embodiments, the first and second sealing panels can include a flexible bellows component and a slidable plastic frame. Additionally, the first and second sealing panels can be designed to fill a window opening around the housing to seal the window opening around the housing. In some embodiments, the first and second sealing panels can be attached to a window using one or more fasteners.

In some embodiments disclosed herein, the front cover can include one or more tabs. The one or more tabs can be configured to removably couple the front cover to the housing. The one or more tabs can be positioned on an upper edge of the front cover. The one or more tabs can have a body portion which can project in a direction that is away from a front face of the housing. The one or more tabs can be released from the receptacles. The one or more receptacles can be located on the housing. Releasing the one or more tabs can permit the front cover to be rotated away from the housing via a horizonal hinge and can permit additional access to a space inside the housing. The body portion can be deflectable. The one or more tabs can be U-shaped. The one or more tabs can be configured to engage one or more receptacles which can be on a front portion of the housing.

In some embodiments disclosed herein, the front cover can be coupled to a horizontal hinge. The horizontal hinge can be positioned at a bottom of the front cover or in a bottom portion of the front cover to expose the opening of the housing. In some embodiments, the horizontal hinge can be located above the ledge and can rotate the front cover in a downward direction away from the housing.

The clamp can include a body portion and a threaded rod. The body portion can be threadably engaged with the threaded rod. The clamp can be configured such that rotating the knob of the clamp in a first direction can translate the body portion along the threaded rod towards an upper front portion of the habitat, which can close the clamp. Rotating the knob of the clamp in a second direction can translate the body portion along the threaded rod away from the upper front portion of the habitat, which can open the clamp.

In some embodiments disclosed herein, a habitat can include for an animal, including: a housing, the housing including: a bottom portion; a first side portion coupled with the bottom portion; a second side portion coupled with the bottom portion; an upper portion coupled with the first side portion and the second side portion; a back portion coupled with the bottom portion, the first side portion, and the second side portion; a space within the housing, the space bounded at least by the bottom portion, the first side portion, the second side portion, and the upper portion; and an opening in communication with the space within the housing;

In some embodiments disclosed herein, the bottom portion of the housing can be cushioned. In some embodiments disclosed herein, the back portion of the housing can include openings or slots. In some embodiments disclosed herein, the habitat can include a housing which can have plurality of slots with a mesh covering. In some embodiments the housing can be made of a clear polycarbonate resin. In some embodiments disclosed herein, the habitat can include one or more clamps positioned on a front portion of the housing.

In some embodiments disclosed herein, the one or more clamps can include a knob. In some embodiments, rotating the knob in a first direction can close the one or more clamps. Closing the one or more clamps when the habitat is positioned in a window opening can couple the habitat to a window.

Some embodiments disclosed herein include a method for positioning an animal habitat in a window. The method can include positioning a housing which can have a bottom portion, a first side portion coupled with the bottom portion, a second side portion coupled with the bottom portion, an upper portion coupled with the first side portion and the second side portion, a back portion coupled with the bottom portion into an opening within a window frame. The method can include advancing at least the back portion of the housing through the opening in the window frame. Additionally, the method can include positioning the bottom portion of the housing on a bottom portion of the window frame. The method can also include sliding a first sealing panel coupled to the housing toward a first side portion of the window frame. The method can include sliding a second sealing panel coupled to the housing toward a second side portion of the window frame. The method can further include sliding a vertical sliding portion of the window downward to a position adjacent to the upper portion of the housing. The method can also include positioning a significant portion of the housing in a region external to the window. The method can also include clamping the house to a lower portion of a window of the window frame. Additionally, the method can include translating a clamp which can include a knob and a threaded rod coupled to the upper portion in a first direction to by rotating the knob along a first path to secure the housing to the window. In some embodiments, the one or more clamps can include a knob, wherein rotating the knob in a first direction can close the one or more clamps. Closing the clamp when the habitat is positioned in a window opening can couple the habitat to a window.

In some embodiments, the method can include sliding the vertical sliding portion of the window downward to slide the vertical sliding portion of the window into the one or more clamps. The method can also include sliding the vertical sliding portion of the window downward to a position adjacent to the upper portion of the housing before clamping the housing to a lower portion of the window. The method can also include clamping the housing to the lower portion of the window of the window frame. Clamping the housing to the window frame can include rotating a threaded rod that passes through a front portion of the housing into a clamp body to tighten the clamp body against the lower portion of the window. The method can also include rotating the knob in a first direction which can close the clamps and can secure the one or more clamps to the vertical sliding portion of the window. In some embodiments, the clamp can include two clamps which can be spaced apart along an upper portion of the habitat. In some embodiments, the method can include a clamp which can translate along a rail to secure the housing to the window. The clamp can be translated in a second direction by rotating the knob along a second path to release the housing from the window.

### BRIEF DESCRIPTION OF THE DRAWINGS

FIG. 1 is a perspective view of an embodiment of a habitat for an animal.

FIG. 2 is a front view of the embodiment of the animal habitat shown in FIG. 1, showing the front cover, along with the door, an opening and hinge which can rotate the door to opened and closed positions.

FIG. 3 is a rear view of the embodiment of the animal habitat shown in FIG. 1, showing the housing, along with the back portion, slots, and an upper portion.

FIG. 4 is a front view of the embodiment of the animal habitat shown in FIG. 1, along with the first side portion, second side portion, and base portion.

FIG. 5 is a side view of the embodiment of the animal habitat shown in FIG. 1, showing the second side portion of the habitat.

FIG. 6 is a rear view of the front cover of the embodiment of the animal habitat shown in FIG. 1, shown removed from the housing, and showing the engagement features for the front cover and engagement features for the ledge.

FIG. 7 is a perspective view of a front side of the embodiment of the front cover shown in FIG. 6.

FIG. 8 shows a close-up of view of the engagement features for securing the housing to the sealing panel.

FIG. 9 is a front view of the embodiment of the front cover shown in FIG. 6, showing the door in an open position.

FIG. 10 shows a perspective view of the embodiment of the animal habitat shown in FIG. 1 positioned in a window.

FIG. 11 shows a rear view of the embodiment of the animal habitat shown in FIG. 1 positioned in a window.

FIG. 12 shows a close-up view of a grasping element on the housing of the animal habitat.

FIGS. 13A-13G show an embodiment of the animal habitat and an embodiment of a method of installation of the animal habitat in a window opening.

FIG. 14 shows an embodiment of the animal habitat showing one or more clamps attached to the animal habitat.

FIG. 15 shows an embodiment of the animal habitat showing a litterbox within the animal habitat, and showing the front cover hinged open in a downward direction.

FIG. 16 shows an embodiment of the animal habitat showing a mesh lining being attached to the animal habitat.

FIG. 17A is a front perspective view of the animal habitat showing the front cover in a closed position.

FIG. 17B is a front perspective view of the animal habitat showing the front cover moved (e.g., rotated) to an open position.

FIG. 17C is rear perspective view of the animal habitat showing one or more clamps coupled with the animal habitat.

FIG. 17D is a front perspective view showing a clamping element and a release element coupled with the animal habitat.

### DETAILED DESCRIPTION

Disclosed herein are embodiments of an animal habitat 100 that can be used to provide an animal (e.g., a cat) with exposure to the outdoors. While the following description often refers to a cat, any embodiments of the animal habitat 100 disclosed herein can be used or configured to be used for any desired animal (e.g., other domestic animals). Therefore, any reference herein to a cat should be understood to include all other animals that can use the habitat. Nonlimiting examples include dogs, pigs, goats, hamsters, Guinea pigs, birds, opossums, and any other pet or domestic animal. Some embodiments of the habitat can be configured to be used to provide the animal with exposure to the outdoors by placing the animal on a ledge or elevated surface that extends through a window opening in a home and into the outdoors.

Some embodiments of the habitat 100 can be modular and can provide a durable and robust cat habitat configured to permit the cat to enter the habitat and for the cat owner to utilize the window. Any embodiments disclosed herein can be configured to allow for the animal to rest outside of a home or apartment without being fully exposed to the outdoors. Some embodiments can permit a cat to enter into a patio, which can be attached to a window frame or otherwise be configured to pass through an open window. In some embodiments, the habitat 100 can generally be shaped similar to a slide out window air conditioning unit. The cat, in this case, can in some embodiments be encapsulated in a box-shaped patio which may be completely enclosed or partially enclosed, or include mesh to provide the cat exposure to the outdoors. Some embodiments of the habitat 100 can be configured to accommodate various weather conditions experienced throughout the country that may affect the usability and durability of the design. Additionally, some embodiments of the habitat can include technological improvements configured to permit the pet owner to utilize the habitat remotely.

The habitat 100 can be used as a resting place for any desired animal, including without limitation, one or more cats, one or more dogs, or other animals. In any embodiments, the habitat can be sized and configured to provide a resting space for a plurality of animals of any kind, domestic or otherwise.

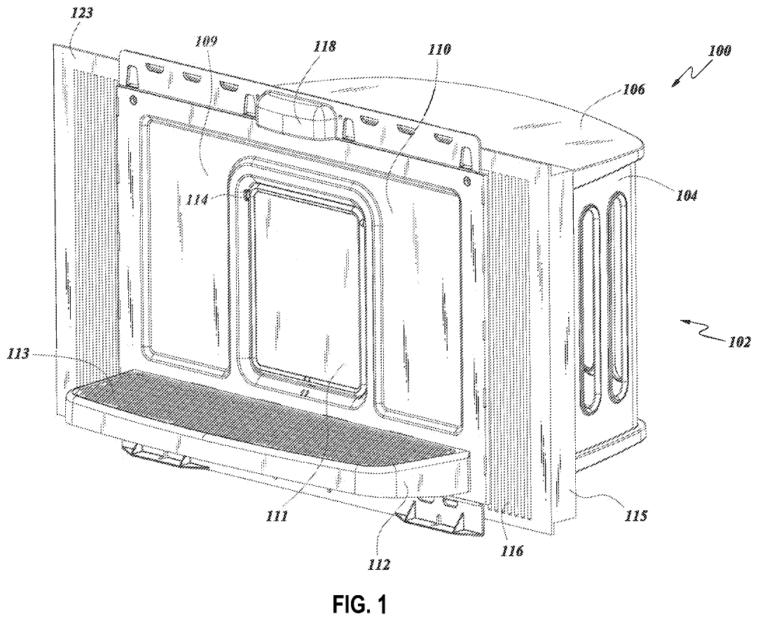

With reference to FIG. 1, in some embodiments, the habitat 100 can include a housing 102 and a front cover 109 coupled to or couplable to the housing 102. In some embodiments, the habitat 100 can also include a ledge 112 removably or nonremovably coupled with the front cover 109, as will be described in greater detail below. The housing 102 can include a bottom portion 103, a first side portion 104 coupled with the bottom portion 103, a second side portion 105 also coupled with the bottom portion 103, an upper portion 106, a back portion 107, a space 108 within the housing 102, and an opening in the housing 102. In some embodiments, the housing 102 can be positioned within a window.

In any embodiment disclosed herein, as shown in the figures, the housing 102 can be monolithically formed with the bottom portion 103, first side portion 104, second side portion 105, upper portion 106, and back portion 107. In other embodiments, the housing 102 can be formed in parts and coupled together into an assembly. The housing 102 can be molded from plastic material (Polyethylene, Polypropylene, or Polyethylene Terephthalate). In some embodiments, the housing 102 can be transparent or can be made of a transparent clear polycarbonate resin material. Advantageously, the housing 102 can be configured to enclose an animal in a space outside of the home, by being coupled to a window. The housing 102 can be configured, in some embodiments, to permit a space and/or an animal within the housing to receive fresh air and/or otherwise be exposed to or partially exposed to the natural elements of the outdoors (e.g., heat, cold, rain, snow, sleet).

In any embodiment disclosed herein, the housing 102 can have a height, a width, and a depth. In some embodiments, the height of the housing 102 can be at least 14.25″. Alternatively, the height of the housing 102 can be at least 12″, 13″, 14″ 15″, 16″, 17″, 18″, 19″, 20″, 21″, 22″, 23″, 24″, 25″, 26″, 27″, 28″, 29,″ or 30″. In some embodiments, the width of the housing 102 can be at least 25.5″. Alternatively, the width of the housing 102 can be at least 12″, 13″, 14″ 15″, 16″, 17″, 18″, 19″, 20″, 21″, 22″, 23″, 24″, 25″, 26″, 27″, 28″, 29,″ or 30″. In some embodiments, the depth of the housing 102 can be at least 13″. Alternatively, the depth of the housing 102 could be 6″, 7″, 8″, 9″, 10″, 11″, 12″, 13″, 14″ 15″, 16″, 17″, 18″, 19″, 20″, 21″, or 22″.

In any embodiment disclosed herein, the housing 102 contains a bottom portion 103, which can provide support for the animal within the housing 102. The bottom portion 103 may additionally be configured to provide haptic feedback to the animal within the habitat. The bottom portion 103 may feature a surface or cushion (e.g., carpet, tile, raised surfaces, domes, grass, artificial turf) to provide the animal with support while in the housing 102 of the habitat 100. Conversely, the bottom portion 103 may be smooth and/or untextured.

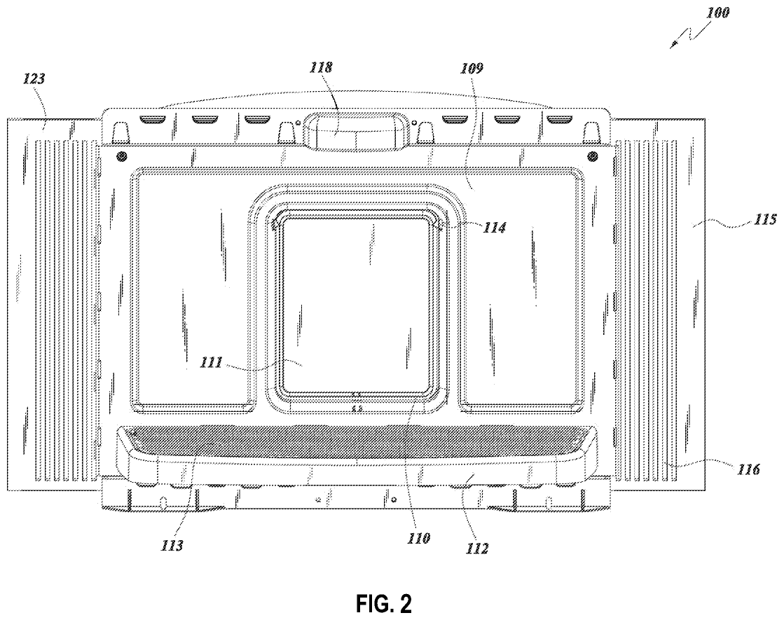

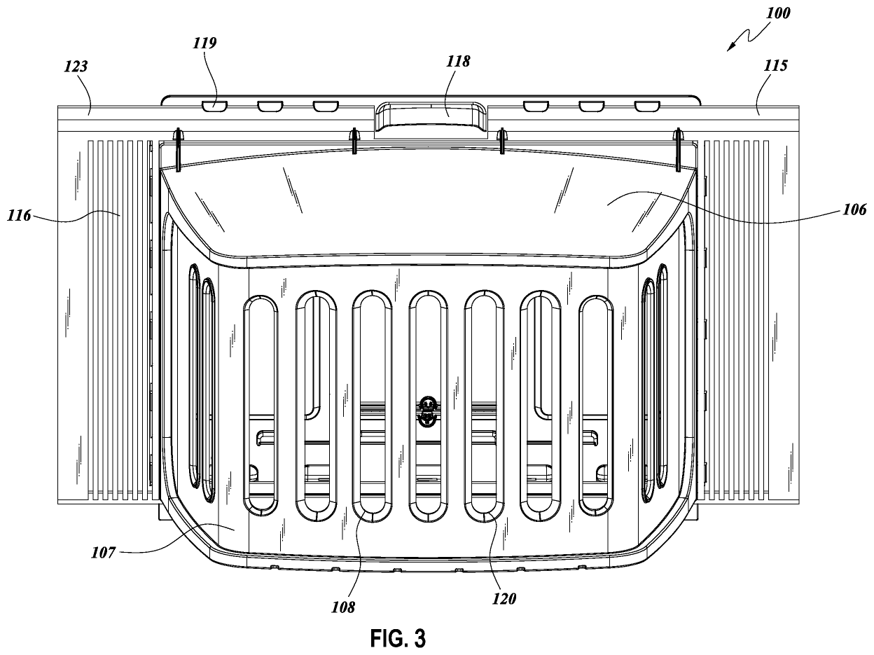

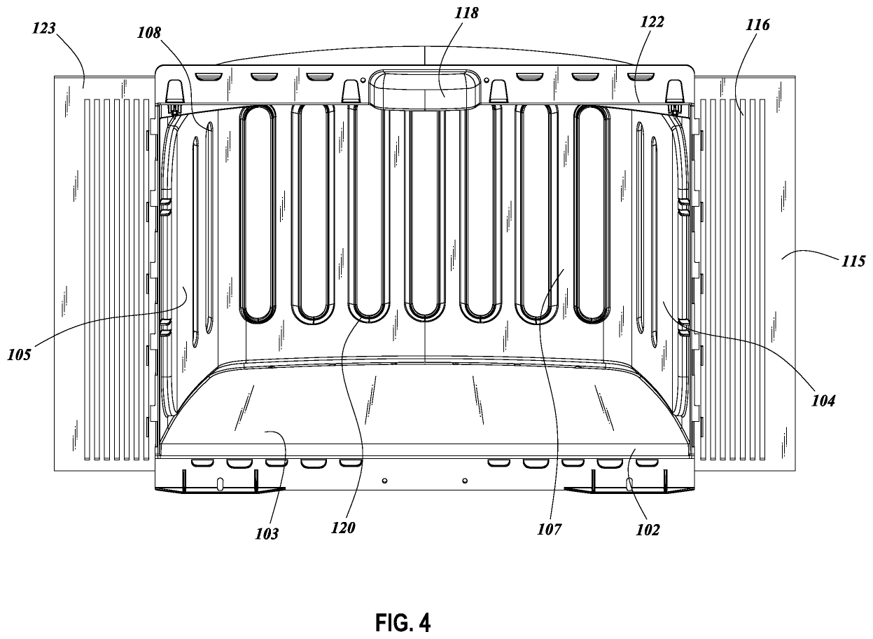

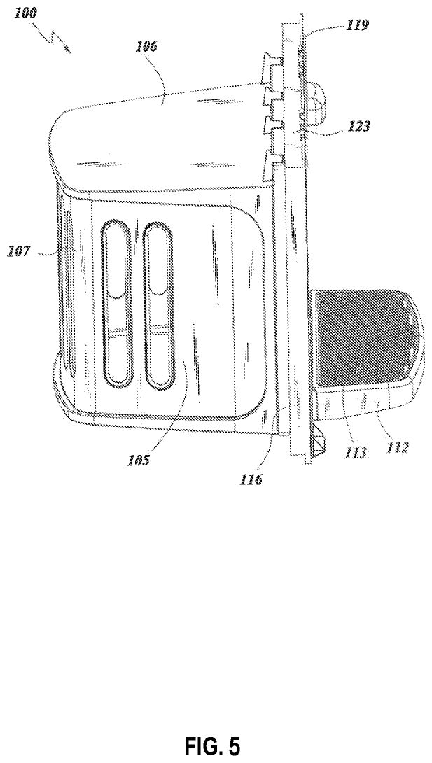

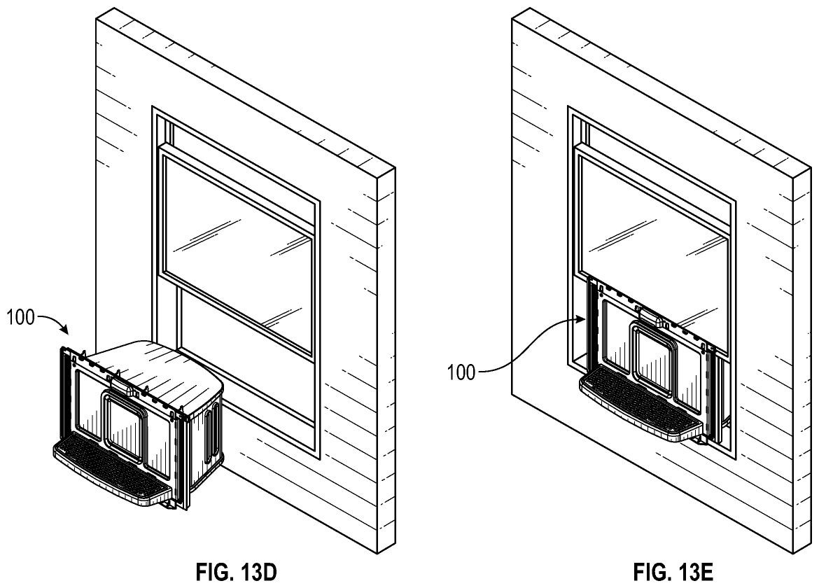

With references to FIGS. 1-5, in any embodiment disclosed herein, the housing 102 can include a first side portion 104 which can be coupled with the bottom portion 103. The first side portion 104 can be molded with the bottom portion 103, forming a singular piece. The first side portion 104 can be a solid wall, the solid wall being opaque. Alternatively, the first side portion 104 can be a solid wall, the solid wall being transparent. In some embodiments, the first side portion 104 can be made from a transparent or clear polycarbonate resin. Additionally, the first side portion 104 can be a wall with openings, such openings may be a plurality of slots, or holes, or cut-out features which provide exposure to the elements outside of the housing 102 of the habitat 100. The first side portion 104 can also have a mesh or a mesh like surface or covering (see, for example, FIG. 14), such that the animal cannot escape, but can see, smell, and feel the outdoors without significant risk of escape or intrusion from an animal outside of the housing. In some embodiments, the first side portion 104 can have a thickness of from 0.08″ or approximately 0.08″ to 0.15″ or approximately 0.15″, or at least 0.10″. Alternatively, the first side portion 104 can have a thickness of at least 0.2″, 0.3″, 0.4″, 0.5″, 0.6″, 0.7″ or 0.8″.

In some embodiments, the first side portion 104 can have ribs, such ribs can be on the interior side of the first side portion 104. The ribs on the first side portion 104 can provide the housing 102 with increased rigidity and can prevent the housing 102 or first side portion 104 from warping under stress or extreme weather conditions. In some embodiments, the first side portion 104 can be embossed, such that portions of the interior surface of the first side portion 104 extends into the space 108 within the housing 102.

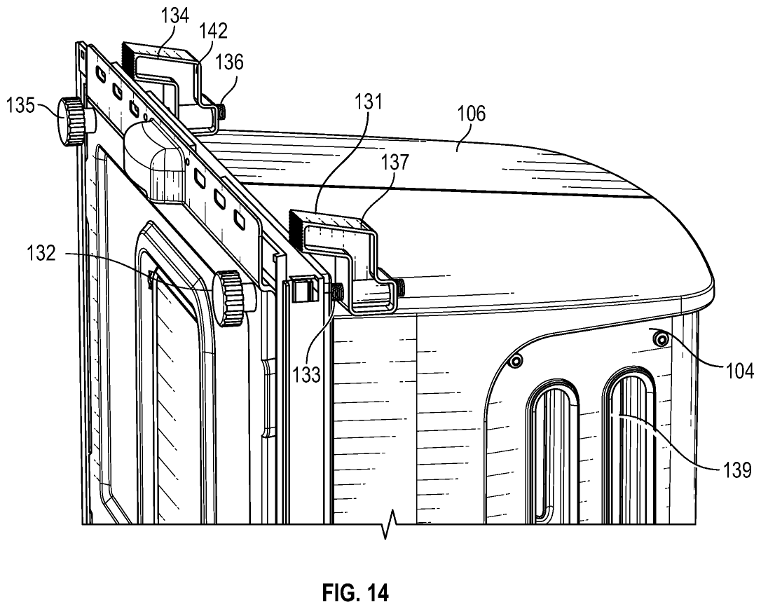

In some embodiments, the plurality of slots 120 on the first side portion 104 can include a supporting structure. This supporting structure can be a bevel or a lip which extends into the space 108 within the housing 102. This supporting structure can, in some embodiments, provide increased strength to the first side portion 104 when the first side portion 104 features a plurality of slots 120. In some embodiments, the supporting structures on the plurality of slots 120 can also prevent the animal within the habitat 100 from reaching outside of the habitat 100 through the plurality of slots 120. In some embodiments, the plurality of slots 120 can have a mesh 139 covering or mesh lining, where the mesh lining can fill the opening of the plurality of slots (sec, for example, FIG. 14 and FIG. 16) which can advantageously prevent debris or winter elements from entering the housing 102. A mesh lining on the first side portion 104 can cover the entirety of the first side portion 104. The mesh or mesh lining can take up 10% to 100% of the first side portion 104. Additionally, the mesh can cover the second side portion 105 of the housing 102. Advantageously, the mesh can cover any holes, slots, or other openings located on the second side portion 105.

In any embodiment disclosed herein, the housing 102 can include a second side portion 105 that can be coupled with the bottom portion 103. The second side portion 105 can optionally have any of the same features or other details as the first side portion 104. In some embodiments, the second side portion 105 can be molded with the bottom portion 103, forming a singular piece. The second side portion 105 can be a solid wall, the solid wall being opaque. Alternatively, the second side portion 105 can be a solid wall, the solid wall being transparent. In some embodiments, the second side portion 105 can be made from a transparent or clear polycarbonate resin. Additionally, the second side portion 105 can be a wall with openings, such openings can be a plurality of slots, or holes, or cut-out features which provide exposure to the elements outside of the housing 102 of the habitat 100. The second side portion 105 can also have a mesh or a mesh like surface or covering, similar to the first side portion 104 (see, for example, FIG. 14 and FIG. 16). The second side portion 105 can have a thickness of at least 0.10″. Alternatively, the second side portion 105 can have a thickness of at least 0.2″, 0.3″, 0.4″, 0.5″, 0.6″, 0.7″ or 0.8″. In some embodiments, the second side portion 105 can have ribs, such ribs can be on the interior side of the second side portion 105. The ribs on the second side portion 105 can provide the housing 102 with increased rigidity and can prevent the housing 102 or second side portion 105 from warping under stress or extreme weather conditions. In some embodiments, the second side portion 105 can be embossed, such that portions of the interior surface of the second side portion 105 extends into the space 108 within the housing 102.

In some embodiments, the plurality of slots 120 on the second side portion 105 can include a supporting structure. This supporting structure can be a bevel or a lip which extends into the space 108 within the housing 102. This supporting structure provides increased strength to the second side portion 105 when the second side portion 105 features a plurality of slots 120. Advantageously, the supporting structure can make the second side portion 105 thicker, providing increased strength. In some embodiments, the supporting structures on the plurality of slots 120 can also prevent the animal within the habitat 100 from reaching outside of the habitat 100 through the plurality of slots 120. In some embodiments, the plurality of slots 120 can have a mesh 139 covering or mesh lining, where the mesh lining can fill the opening of the plurality of slots (sec, for example, FIG. 14 and FIG. 16). In some embodiments, the mesh covering or mesh lining can advantageously prevent debris or winter elements from entering the housing 102. A mesh lining on the second side portion 105 can cover the entirety of the second side portion 105. The mesh or mesh lining can take up 10% to 100% of the second side portion 105.

In any embodiment disclosed herein, the housing 102 can include an upper portion 106 that can be coupled with the first side portion 104 and the second side portion 105. The upper portion 106 can be molded from plastic (e.g., Polyethylene, Polypropylene, or Polyethylene Terephthalate). Advantageously, the upper portion 106 can be able to protect the habitat 100 and the animal within the habitat 100 from natural elements. The upper portion 106 can be a solid wall, the solid wall can be sloped at a downwards angle to permit rain, water, debris, or any other natural or unnatural substance to run off of the upper portion 106 and onto a lower surface. The upper portion 106 can be configured to operably bias water to drain from the upper portion. For example and without limitation, in any embodiments disclosed herein, the upper portion 106 can have a convex curve. This can, in some embodiments, cause or bias water and or other objects to roll off of the upper portion 106. Additionally, in some embodiments, the upper portion 106 can be configured to overhand the side portions and/or other portions of the housing to bias water to drip from the upper portion 106 away from the housing 102 and inhibit (e.g., prevent) water from dripping from the from the upper portion 106 down the side portions of the housing.

The upper portion 106 can be opaque such that it prevents light from entering from the upper portion 106. Additionally, the upper portion 106 can also be transparent or semi-transparent, so as to allow at least some light to enter the housing through the upper portion 106. The upper portion 106 and/or any portion of the housing 102 can be thermally insulated, to permit or improve year-round use. Additionally, the upper portion 106 can be untextured, to allow natural or unnatural substances to run-off the upper portion 106. Additionally, the upper portion 106 and/or any other portion of the housing 102 can be textured or capable of receiving an external item for display (e.g., figurine, toy, address, decal). In some embodiments, the upper portion 106 can be made from a transparent or clear polycarbonate resin.

In some embodiments, the upper portion 106 can include one or more ribs to provide additional stability and rigidity to the upper portion 106 and the housing 102. Advantageously, the one or more ribs can fully extend from a front edge of the upper portion 106 to a rear edge of the upper portion 106. Additionally, the upper portion 106 can have one or more ribs that fully extend from the leftmost edge of the upper portion 106 to the rightmost edge of the upper portion 106. In some embodiments, the one or more ribs can only extend partially from the front most edge of the upper portion 106 to the rear most edge of the upper portion 106. Additionally, in some embodiments, the one or more ribs can only partially extend in a direction from a front edge of the upper portion 106 to a rear edge of the upper portion 106 and over a ridge on the upper portion 106. In some embodiments the ridge on the upper portion 106 can be used to provide additional support to housing 102. In some embodiments, the ridge on the upper portion 106 can be used to support a first sealing panel 115 and a second sealing panel 123.

In some embodiments, the upper portion 106, first side portion 104, second side portion 105, the bottom portion 103, and/or other portions of the housing 102 can be monolithically formed. The monolithic housing embodiment can be molded, formed, printed, or created in any other process that results in a monolithic housing 102.

In any embodiments disclosed herein, the housing 102 can include a back portion 107 which can be coupled with the bottom portion 103, the first side portion 104 and the second side portion 105. As with other components of the habitat 100, the back portion 107 can be molded from plastic (e.g., Polyethylene, Polypropylene, or Polyethylene Terephthalate). Advantageously, the back portion 107 can be configured to protect the habitat 100 and the animal within the habitat 100 from natural elements, or at least provide some protection thereto. Additionally, in some embodiments, the back portion 107 can include one or more holes along a bottom edge of the back portion 107. The holes can allow air to pass through the habitat 100 and into the space 108 within the housing 102. Additionally, the holes on the bottommost edge of the back portion 107 can provide manufacturing benefits (e.g., 3D molding, injection molding, casting). In some embodiments, the holes on the bottom edge of the back portion 107 can be used as drain holes so that any water or elements that enter the habitat 100 can drain from the holes on the bottom edge of the back portion 107. In some embodiments, the back portion 107 can include one or more holes along a top edge of the back portion 107.

In some embodiments, the back portion 107 can have a plurality of slots 120. The slots 120 in some embodiments can be sized and configured so as to not extend completely to the upper surface and/or lower surface. Terminating the slots at a height that can be above the bottom portion 103 can prevent rain and water from passing through the slots and entering the housing 102. In other embodiments, the slots 120 can extend completely from the upper portion 106 to the bottom portion 103.

In some embodiments, the back portion 107 can include a plurality of slots 120 where the plurality of slots 120 can be covered by mesh 139 or a mesh lining (see, for example, FIG. 14 and FIG. 16). The mesh 139 can be placed on the back portion 107 and can be shaped to fit on the back portion 107. In some embodiments, by placing the mesh 139 on the back portion 107 the mesh can cover the plurality of slots 120. Alternatively, in some embodiments, the mesh 139 can be shaped similarly, if not identically, to the dimensions of the plurality of slots 120. Alternatively, the back portion 107 can have a plurality of slots 120 that extend in a vertical direction when the housing 102 is in an operable position. Additionally, the plurality of slots 120 on the back portion 107 can have a height in the vertical direction that is less than or equal to 90% of a total height of the back portion 107 in a vertical direction. This embodiment provides protection for the habitat 100 from external weather events (e.g., rain, snow, hail, sleet, dust) but also provides exposure to natural elements. In some embodiments, the plurality of slots 120 can have a height in the vertical direction that is less than or equal to (or approximately) 25%, 50%, 70%, 75%, and 80% of a total height of the back portion 107 in a vertical direction.

In some embodiments, the plurality of slots 120 can be spaced apart from a bottom edge of the back portion 107 by a distance that is at least 5% of a total height of the back portion 107 in a vertical direction. In other embodiments, the plurality of slots 120 can be spaced apart from a bottom edge of the back portion 107 by a distance that is between 2% or approximately to 15% or approximately 15% of a total height of the back portion 107 in a vertical direction.

In some embodiments, the plurality of slots 120 on the back portion 107 can be equidistantly spaced apart. This embodiment can make manufacturing the back portion 107 simpler and provide sufficient outdoor exposure. Alternatively, the plurality of slots 120 can be placed in locations that are not spaced equidistantly apart. This embodiment can provide unique benefits to the enclosed animal (e.g., protection from debris, wind, nature). In some embodiments, the plurality of slots can have a width that is less than 5% or approximately 5% of the back panel. In other embodiments, the plurality of slots can have a width that is less than 10% or approximately 10%, less than 15% or approximately 15%, less than 20% or approximately 20%, less than 25% or approximately 25%, or less than 30% or approximately 30%, of the back panel.

In some embodiments, the plurality of slots 120 on the back portion 107 can include a supporting structure. This supporting structure can be a bevel or a lip which extends into the space 108 within the housing 102. This supporting structure provides increased strength to the back portion 107 when the back wall features a plurality of slots 120. Advantageously, the supporting structure can make the back portion 107 thicker, providing increased strength. In some embodiments, the supporting structures on the plurality of slots 120 can also prevent the animal within the habitat 100 from reaching outside of the habitat 100 through the plurality of slots 120.

In some embodiments, the back portion 107 can be a solid wall, where the solid wall can be opaque. In other embodiments, the back portion 107 can be a solid wall, but the solid wall transparent. The back wall is not limited to being solid or slotted. The back portion 107 can include holes, mesh, slots, or other openings which allow the housing 102 to be exposed to external elements. A mesh lining on the back portion 107 can cover the entirety of the back portion 107. The mesh or mesh lining can take up 10% to 100% of the back portion 107. Additionally, the mesh can cover the plurality of slots 120 of the housing 102. Advantageously, the mesh can cover any holes, slots, or other openings located on the first side portion 104 and second side portion 105 of the housing 102. The back holes in the back portion 107 of the habitat 100 might take up at least 25%, 50%, or 75% of the total area of the back portion 107. In some embodiments, the back wall will be composed of plastic (e.g., Polyethylene, Polypropylene, or Polyethylene Terephthalate).

In some embodiments, the back portion 107 can be monolithically formed with the bottom portion 103, first side portion 104, second side portion 105, and upper portion 106, making the entire housing 102 one monolithic component. This one piece can be molded, formed, printed, or created in any other process that results in a single component.

In any embodiments, there can be a space 108 within the housing 102, the space 108 can be bounded by at least the bottom portion 103, the first side portion 104, the second side portion 105, and the upper portion 106. In some embodiments, the space 108 can be bounded by the back portion 107. The space 108 within the housing 102 can be configured to house an animal. In some embodiments, the space 108 within the housing 102 can be configured to allow the animal(s) to see the outdoors. The space 108 within the housing 102 in those embodiments can have bounded portions which feature slots, holes, mesh, or some other feature that allows the animal to have exposure to the external environment. In some embodiments, the housing 102 can be selectively or non-selectively configured to prevent any exposure to the external environment.

In some embodiments, the space 108 within the housing 102 might be completely textured such that there can be haptic feedback for the animal. In some embodiments, the space 108 might feature a toy or device which can keep the animal entertained or keep the animal company.

In some embodiments, there can be an opening in the housing 122. The opening in the housing 122 can be disposed in the front of the housing 102. Additionally, a perimeter of the housing 102 around the opening in the housing 122 can be configured to couple with another portion. For example, the housing 102 can be designed to receive a front cover 109, which can be a solid singular piece or can be made of a plurality of different pieces coupled together. In some embodiments, the perimeter of the housing 102 around the opening in the housing 122 can have one or more locating holes or other locating features, such that a front cover 109 or another portion can be properly aligned with the housing 102 when the front cover 109 or other portion are coupled to the housing 102. In some embodiments, the front cover 109 can be configured to cover all or a portion of the opening in the housing 102. This would operably close the window opening in the house and prevent external air from passing through the window opening. In some embodiments, the habitat 100 can be configured such that the habitat 100 can be used without any front cover 109. Thus, the opening in the body can remain open so that the habitat 100 remains open. In this example, the opening in the housing 122 will allow the habitat 100 to partially function as an open window and receive natural air or other elements.

In some embodiments disclosed herein, the opening in the housing 122 can be a variety of shapes or sizes. Advantageously, the opening in the housing 122 can be shaped similar to a rectangle. The width of the opening in the housing 122 can be at least 12″, 13″, 14″ 15″, 16″, 17″, 18″, 19″, 21″, 22″, 23″, 24″, 25″, 26″, 27″, 28″, 29,″ or 30″. In some embodiments, the height of the opening in the housing can be at least 12″, 13″, 14″ 15″, 16″, 17″, 18″, 19″, 21″, 22″, 23″, 24″, 25″, 26″, 27″, 28″, 29,″ or 30″.

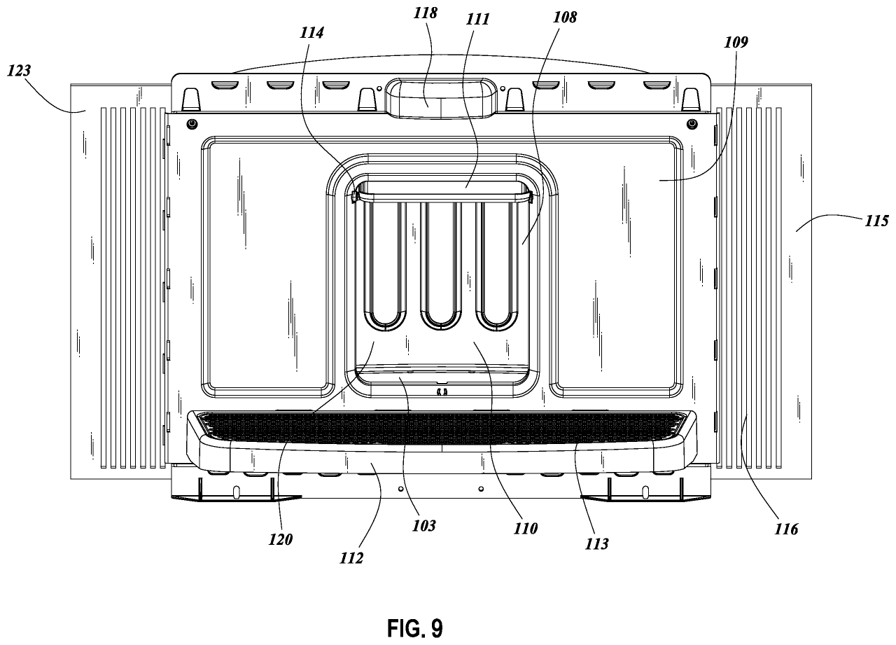

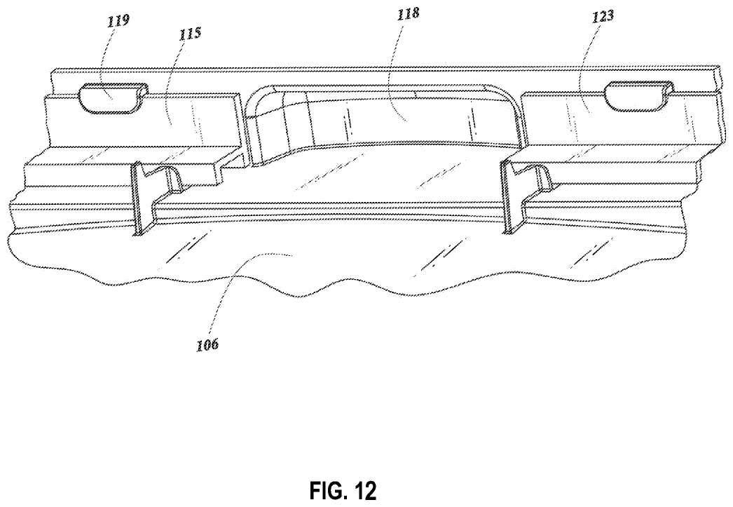

With reference to FIGS. 1-4, 9 and 12, in some embodiments, the housing 102 (which can include the front cover 109) can include a grasping element 118. The grasping element 118 can be configured to provide the user with the ability to lift and move the habitat 100 with increased case and simplicity. The grasping element 118 can be configured to permit a user to lift at least the front cover with one or both hands by engaging the grasping element with one or both hands. The grasping element 118, in some embodiments, can be a handle. The grasping element 118, in some embodiments can be monolithically formed with housing 102. Advantageously, this limits the number of components, cases assembly, and provides the user with a novel place to lift the habitat 100. In other embodiments, the grasping element 118 on the housing 102 can be formed separately from the housing 102 and can be fastened to the housing 102. This allows for the habitat 100 to utilize a variety of grasping elements 118 for various ergonomic purposes. In some embodiments, the grasping element 118 can be located at an upper portion of the habitat, for example and without limitation, at or near an upper portion of the front opening or front cover on the housing 102. In other embodiments, one or more grasping elements 118 can be located on a side portion of the housing 102 near the front opening on the housing 102. Alternatively, the grasping element 118 can be located on the upper portion 106 of the housing 102.

In some embodiments, the housing 102 can include engagement features that allow the housing 102 to removably couple to the front cover 109. These engagement features can include hook receiving features on the housing 102. Functionally, these hook receiving features allow the front cover 109 to easily slide on the housing 102. In another embodiment, the engagement features can be snap like features, which can have a tolerance fit permitting the front cover 109 to securely engage the housing 102. When pressure is applied, the engagement features will bend/flex allowing the front cover 109 to be removed.

Any embodiments of the habitat disclosed herein can have a first sealing panel 115 and/or a second sealing panel 123. In some embodiments, the housing 102 can include engagement features that allow the housing 102 to removably couple to the first sealing panel 115 and the second sealing panel 123. The engagement features can be located above the opening in the housing 122. The engagement features can be hook shaped and can be aligned in such a way that the engagement features can create a channel. In some embodiments, the channel that can be created by the engagement features can be designed such that a first sealing panel 115 and a second scaling panel 123 can slide into a position which allows a first sealing panel 115 and a second scaling panel 123 to be operably connected to a window and connected to the housing 102. In some embodiments, the housing 102 can also have engagement features to couple a first scaling panel 115 and a second sealing panel 123 to the housing 102 (e.g., screws, bolts, clamps, rivets, pins, clips, or any suitable fastening device). In some embodiments, the engagement features can be located above the opening in the housing 122 and can require tooling to couple a first sealing panel 115 and a second sealing panel 123 to the housing 102. In some embodiments, the first sealing panel 115 and the second sealing panel 123 can be coupled to the housing 102 without the use of fasteners. In some embodiments, the first sealing panel 115 and the second sealing panel 123 can be coupled to the housing 102 without the use of tools. In some embodiments, at least a portion of the first sealing panel 115 and the second sealing panel 123 can be integrally formed with the housing 102.

In some embodiments, the housing 102 can include engagement features that allow the housing 102 to be removably coupled to a window. For example and without limitation, some embodiments of the habit 100 and/or housing 102 can be configured to be coupled to a window opening and/or a window without the use of any screws. Some embodiments of the habitat 100 and/or housing 102 can be configured to be coupled to a window opening and/or a window without any fasteners penetrating through any portion of the window frame or windows.

In some embodiments, the engagement features can be located at a position below the housing 102 and can secure the housing 102 to a window. The engagement features can create a channel, where the channel engages a portion of the window to secure the housing 102 to the window. The engagement feature can be a snap like feature, which has a tolerance fit, which can permit the engagement feature to securely engage the window to prevent the housing 102 from freely moving within the window. The engagement features can be configured to bend or flex when pressure is applied, allowing the housing 102 to be removed from the window.

### Front Cover:

In some embodiments, the front cover 109 can be removably coupled with the housing 102. In some embodiments, the front cover 109 can be configured to extend across the housing 102 from the first side portion 104 to the second side portion 105 and from the bottom portion 103 to the upper portion 106. In some embodiments, the front cover 109 can be removably coupled with the housing 102 via a series of engagement features 117, with other fasteners or connecting features, with an interference fit, or otherwise. In some embodiments, when the front cover 109 is selectively placed near the coupling areas on the housing 102, the front cover 109 can be removably connected to the housing 102. Functionally, this allows the front cover 109 to be removed from the housing 102 quickly and without tools (e.g., removably by hand). In other embodiments, the front cover 109 and/or the ledge 112 can be fastened into the housing 102 via screws (such as hand screws or thumb screws), bolts, clamps, rivets, pins, clips, or any suitable fastening device. Advantageously, this will permit the front cover 109 to be coupled into place after assembly without worry that the front cover 109 could be removed quickly. Therefore, in any embodiments herein, the front cover 109 can be configured to be removed from the housing by hand and without the use of any tools.

In some embodiments, the front cover 109 can be made in a variety of different sizes and shapes. Advantageously, the front cover 109 can have a rectangular shape. The width of the front cover 109 can be least or approximately 12″, 13″, 14″ 15″, 16″, 17″, 18″, 19″, 21″, 22″, 23″, 24″, 25″, 26″, 27″, 28″, 29,″ or 30″. Additionally, the front cover 109 can have at least or approximately a height of 7″, 8″, 9″, 10″, 11″, 12″, 13″, 14″ 15″, 16″, 17″, 18″, 19″, 21″, 22″, 23″, 24″, 25″, 26″, 27″, 28″, 29,″ or 30″.

In some embodiments, the front cover 109 can have a rightmost and leftmost edge. The rightmost edge on the front cover 109 can have a side wall. The side wall in this embodiment can have a channel. The channel in this embodiment can extend from the top of the front cover 109 to the bottom of the front cover 109. In some embodiments, the channel can be adjacent to a retaining wall. In some embodiments, the channel can be parallel to a retaining wall. The retaining wall, in some embodiments can contact the housing 102 when the front cover 109 is removably connected to the housing 102. Advantageously, this can allow the front cover 109 to remain removably connected to the housing 102 when the habitat 100 is placed in a window unit.

Additionally, in some embodiments, the leftmost edge on the front cover 109 can have a side wall. The side wall in this embodiment can have a channel. The channel in this embodiment can extend from the top of the front cover 109 to the bottom of the front cover 109. In some embodiments, the channel can be adjacent to a retaining wall. In some embodiments, the channel can be parallel to a retaining wall. The retaining wall, in some embodiments, can interact with the housing 102 when the front cover 109 is removably connected to the housing 102.

In some embodiments, the front cover can include one or more engagement features 117 which can be snap fit joints. One or more engagement features 117 can be located in a channel near the rightmost edge or a leftmost edge of the front cover 109. The engagement features 117 can extend downwards though the channel from the top of the front cover 109 to the bottom of the front cover 109. The engagement features 117 can be cantilever snap joints or torsion snap joints. The engagement features 117 can have a tapered hook or catch at the tip configured to engage the housing 102. In some embodiments, the engagement features 117 can bend when the front cover 109 is being operably placed on the housing 102. In other embodiments, the engagement features 117 can bend (e.g., can be bent) when the front cover 109 is being removed from the housing 102. In any embodiment, the front cover 109 can be removed by hand, without tooling from the housing 102.

Alternatively, the front cover 109 can be operably attached or coupled to the housing 102 so that the front cover 109 is not removable. The front cover 109 can be fastened into the housing 102 via screws, bolts, clamps, or any similar fastening device. In some embodiments, the front cover 109 can be monolithically formed with the housing 102, such that the front cover 109 and the housing 102 are one component. The monolithically formed front cover 109 and housing 102 can be molded, formed, printed, or created in any other process that results in a single component.

In some embodiments, the front cover 109 can include engagement features 117 configured to allow the front cover 109 to slide into tracks coupled with or formed as part of the housing 102. These engagement features can include hook features which extend over the housing 102. Functionally, these hook features can allow the front cover 109 of some embodiments of the animal habitat to slide onto the housing 102. In another embodiment, the engagement features can be snap like features, which have a tolerance fit permitting the front cover 109 to securely engage the housing 102. When pressure is applied, the engagement features can bend/flex allowing the front cover 109 to be removed.

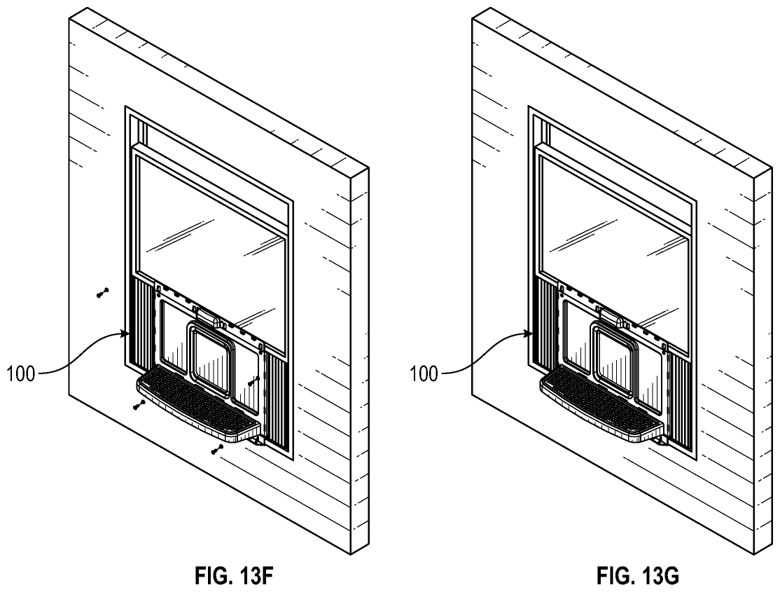

In some embodiments, the front cover 109 can be hinged to the housing 102 so that the front cover can be hinged open while remaining coupled to the housing 102 (see, for example, FIG. 15). The hinge 160 on the front cover 109 can be located at the bottom of the front cover 109, or in a lowermost portion or bottom portion of the front cover 109. For example and without limitation, the horizontal hinge 160 on the front cover can be located ⅛^{th} or approximately ⅛^{th}, or 1/10^{th} or approximately 1/10^{th}, or less than 1/10^{th} of the height of the front cover from the bottom of the front cover 109. The hinge 160 and other components of the animal habitat can be configured such that, when the front cover 109 is hinged open (e.g., the front cover 109 rotates open in a downward direction), a user can easily access the space 108 within the housing 102. The hinge 160 on the front cover 109 (or other rotation mechanism located at the bottom of the front cover 109 or along one of the sides of the front cover 109) can be configured to rotate the front cover 109 relative to the space 108 within the housing 102 between an open position (e.g., front cover 109 rotated downward or otherwise to an open position) and a closed position (e.g., front cover 109 can be coupled to the housing 102 and the top rightmost edge and the leftmost edge of the front cover 109 can be removably coupled to the housing 102).

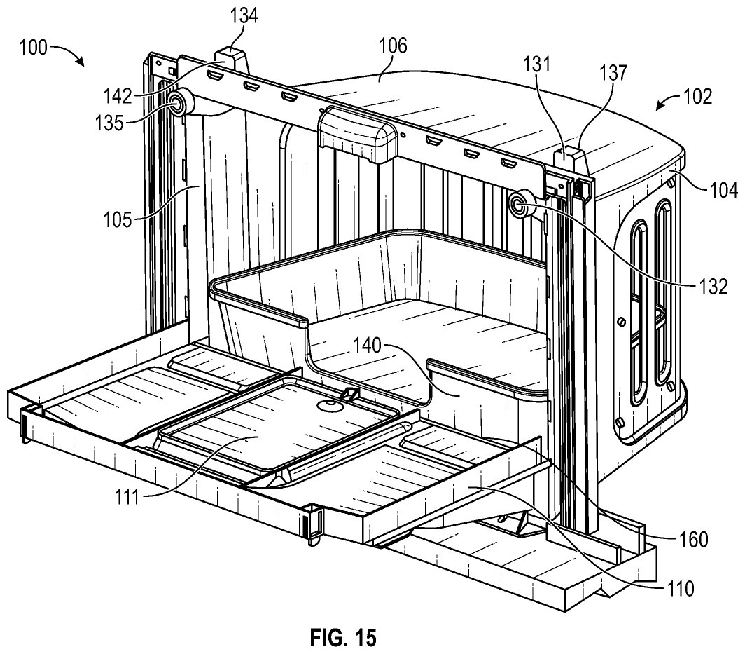

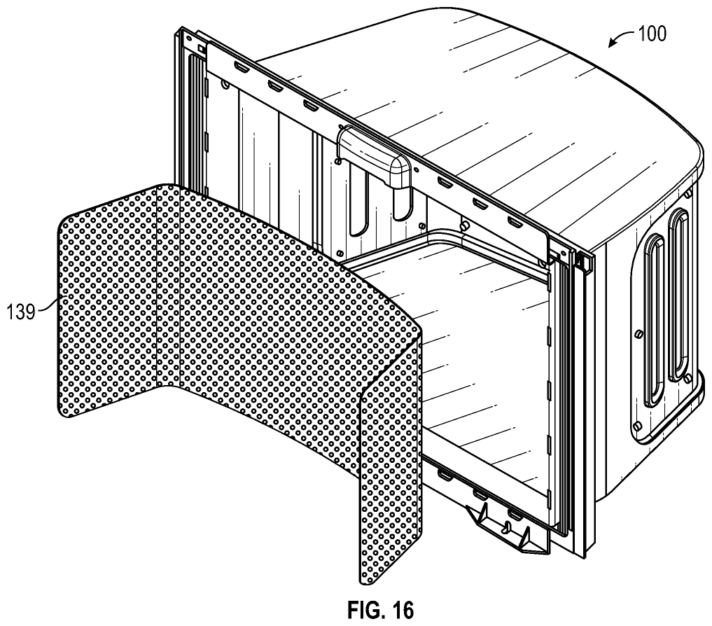

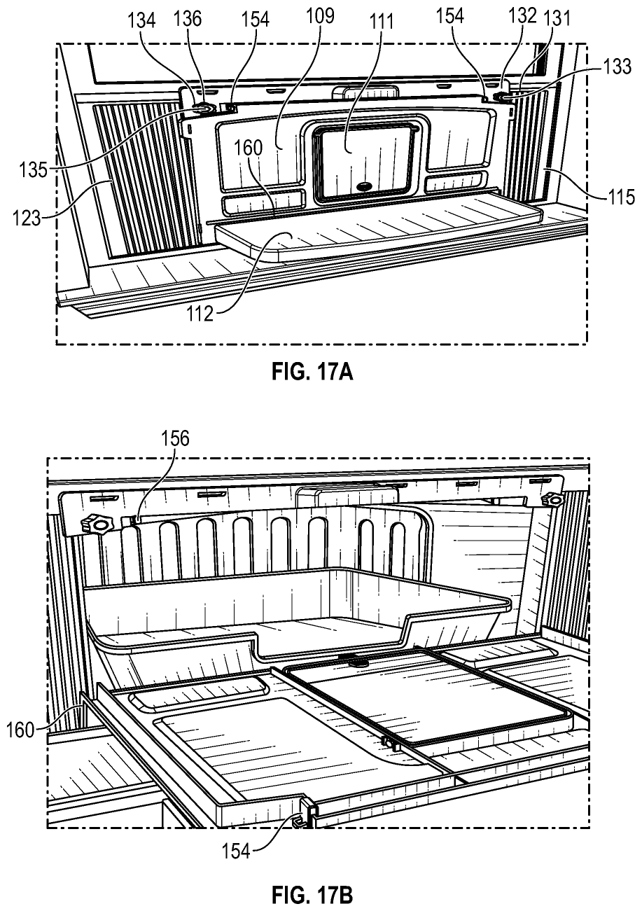

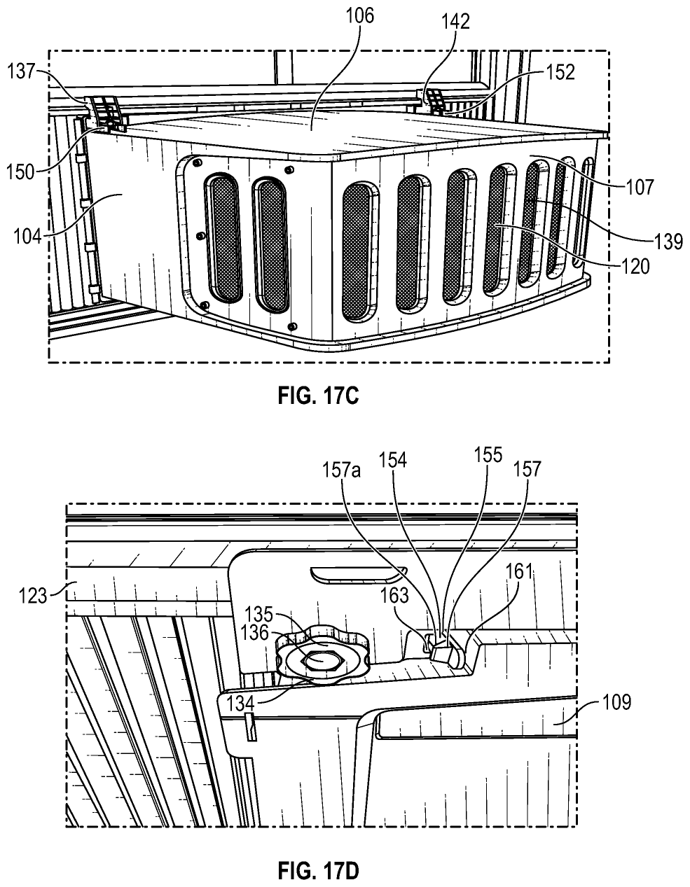

In some embodiments, the hinge at the bottom of the front cover 109 can operably allow the front cover 109 to swing away from the housing 102 which can permit the animal to enter the space 108 within the housing 102 and can provide an extended surface to support the animal before entering the housing. The hinge at the bottom of the front cover 109 can be a horizontal hinge 160 (see, e.g., FIG. 17B). The horizontal hinge 160 can be located above the ledge 112. Advantageously, hinging the front cover 109 at or near the bottom of the front cover can allow a user to easily close the front cover 109 with one or more hands. A user can operably push a top portion of the front cover 109 upwards and towards the housing 102 to place the front cover 109 in a closed position.

In other embodiments, the front cover 109 can have a hinge or other rotation mechanism that can be located on any side of the front cover (e.g., top, left, right, bottom). In these cases, the hinge or rotation mechanism on the front cover 109 can be configured to operably allow the animal to gain access to the housing 102 and exit back into the home. Advantageously, the hinged front cover 109 can allow a user to clean or maintain the habitat. In some embodiments, a litter box can be positioned within the housing 102 (see, for example, FIG. 15). Advantageously, by hinging the front cover 109 in a downward direction, a user can easily enter or gain access to the space 108 within the housing 102 to place a new or clean litter box in the space 108 or remove the litter box within the housing 102 for cleaning. In some embodiments, the front cover 109 can have one or more tabs 154, the one or more tabs 154 can permit the front cover 109 to be secured to the housing 102 and can prevent the front cover 109 from opening (see e.g., FIG. 17A-17B, and FIG. 17D). Functionally, when a user releases the one or more tabs 154 on the front cover 109, the front cover 109 can hinge open and away from the housing 102. In some embodiments, the front cover 109 can be operably removed from the hinge and, therefore, can be removed from the housing 102.

In some embodiments, the one or more tabs 154 on the front cover 109 can be positioned on an upper edge of the front cover 109. The one or more tabs 154 can include a first tab and a second tab. The first tab can be located on an upper left edge of the front cover 109 and the second tab can be located on an upper right edge of the front cover 109. When a user pushes (e.g., deflects) the first tab or the second tab, the front cover 109 can operably be released from the housing 102 and rotate in a downward direction away from the housing 102 about the hinge. For example and without limitation, in some embodiments, each of the tabs 154 can have a body portion 155 that projects away from a front face of the housing and that is deflectable. Each of the tabs 154 can also have a projection 157 (e.g., a tooth or other protrusion or engagement feature) that extends away from the body portion 157 of the tab 154 at an angle such that, when the tab 154 is in a first, relaxed position, the projection 157 will engage the complementary features of or coupled with the front of the housing to inhibit (e.g., prevent) the front cover from moving away from the housing. When the tab 154 is in a second, deflected position, the projection 157 will pass through an opening 161 in the front face of the housing. In some embodiments, the projection 157 can have a beveled or angled front face 157A that is configured to bias the tab 154 and projection 157 to deflect toward the second position of the tab (e.g., to cause the tab 154 and projection 157 to deflect automatically toward the second position of the tab) as the tab 154 is being advanced into the opening 161 (e.g., without limitation, as the front cover 109 is being moved to the closed position) so that the projection 157 can pass through the opening 161 in the front of the housing 109 without the user having to directly move or deflect the tab 154. Additionally, in some embodiments, the opening 161 in the front of the housing 109 can also have an angled or beveled edge feature 163 configured to bias the tab 154 and projection 157 to deflect toward the second position of the tab (e.g., without limitation, to cause the tab 154 and projection 157 to deflect automatically toward the second position of the tab) as the tab 154 is being advanced into the opening 161. As shown in FIG. 17B, some embodiments of the one or more tabs 154 can be U-shaped, where when a user engages or pushes the one or more tabs 154, the U-shape can compress or bend, as described above.

In some embodiments, a front portion of the housing 102 can have one or more receptacles 156. The one or more receptacles 156 can each receive each of the one or more tabs 154 in the opening 159 of the receptacle. Since the one or more tabs 154 can be operably connected to the front cover 109, when the one or more tabs 154 are engaged with the receptacles and in the locked position or state, the front cover 109 will be secured to the front portion of the housing. Therefore, in some embodiments, when the front cover 109 is in a closed position, a user can deflect the one or more tabs 154 and the U-shape of the one or more tabs 154 can bend or compress, thereby permitting the one or more tabs 154 to be released from the receptacles 156 so that the front cover 109 can rotate open and away from the housing 102. Advantageously, the one or more tabs 154 can allow the top edge of the front cover 109 to be quickly released from the housing 102. Therefore, a user can easily enter the housing to remove a litter box or clean the space 108.

In some embodiments, the front cover 109 can be operably removed from the housing 102 which permits the habitat 100 to receive airflow through the housing 102, through the space 108 within the housing 102, and through the opening in the housing 122 to permit air to flow through a window that the habitat is positioned within. Advantageously, the front cover 109 can be operably connected to the housing 102 to prohibit airflow by restricting air from entering through the housing 102, through the space 108 within the housing 102, and through the opening in the housing 122 to prohibit air to low through a window that the habitat is positioned within.

In some embodiments, the front cover 109 and/or any other components of the habitat can be opaque. This permits the animal to be secluded from the remainder of the home. Alternatively, the front cover 109 can be transparent. This allows for the animal within the habitat 100 to see inside the interior of the home and conversely the owner can see if the pet is within the habitat 100. In some embodiments, the front cover 109 can be made from a transparent or clear polycarbonate resin.

In some embodiments, the front cover 109 can have an opening 110 which is configured to allow an animal to enter the housing 102 of the habitat 100. The opening 110 of the front cover 109 can be located in the middle of the front cover 109, or off to one side of the front cover 109. The opening 110 on the front cover 109 can be various different sizes and shapes. The opening 110 can have at least or approximately a width of 3″, 4″, 5″, 6″, 7″, 8″, 9″, or 10″. Additionally, the opening 110 can have at least or approximately a length of 3″, 4″, 5″, 6″, 7″, 8″, 9″, or 10″. The opening 110 in the front cover 109 can operably fit a small door 111 which permits an animal to enter and exit the housing 102 of the habitat 100.

In some embodiments, the front cover 109 can have a door 111 that can be coupled with the opening in the front cover 109. The door 111 can allow the animal to enter and exit the housing 102 as desired. The door 111 in some embodiments can have a hinge 114 or other rotation mechanism located at the top of the door 111. In some embodiments, the door 111 can be configured to rotate relative to the opening in the front cover between the open position and the closed position. The hinge 114 at the top of the door 111 operably allows the door to swing into and out of the space within the housing 102 to permit the animal to enter the space 108 within the housing 102. In other embodiments, the door 111 can have a hinge 114 or other rotation mechanism that can be located on any side of the opening e.g., top, middle, bottom). In these cases, the hinge 114 or rotation mechanism on the door can be configured to operably allow the animal to gain access to the housing 102 and exit back into the home. Additionally, the door 111 can be textured, embossed or capable of receiving an external item for display (e.g., figurine, toy, address, decal, display screen).

In some embodiments, the door 111 can be biased to the closed position and/or to the open position. In some embodiments, the door 111 can be biased to the closed position using one or more pairs of magnets or ferrous components in combination with magnets. The ferrous component and/or magnet can be located in the middle of the door 111. Additionally, there can be a second ferrous component which can be located inferior to the door 111 to bias the door to a closed position. In some embodiments, the door 111 can be biased to the closed position using at least one magnet coupled with the housing (e.g., in an embodiment wherein a bottom surface of the door extends to the bottom of the front cover so as to be close enough to the housing to experience magnetic attraction from a magnet coupled with the housing), the front cover 109 or the door 111 and at least one ferrous element coupled with the other of the housing, the front cover 109 or the door 111. In some embodiments, the front cover 109 can have a groove for a ferrous element or magnet which can operably bias the door 111 to a closed position. The front cover 109 can have a groove located on the on the bottom edge of the opening 110.

In some embodiments, the door 111 can be opaque to prevent one from looking into the back portion 107 of the habitat 100, through door 111 and into the home. The door 111 can be made of plastic (e.g., Polyethylene, Polypropylene, or Polyethylene Terephthalate). The door 111 can be made from a transparent or clear polycarbonate resin. In other embodiments, the door 111 can be transparent and composed of acrylic, glass, or another suitable material. In another embodiment, the door 111 can be made of or include mesh. In this arrangement, the mesh or mostly mesh door can provide for air passage through the door, even when the door is in the closed position. For example, and without limitation, the door 111 can function similar to a screen door or a window screen. In this embodiment, the home can receive airflow when air passes through the housing 102, through the space 108 within the housing 102, and through the mesh door 111 coupled with the front cover 109, even if the door 111 is closed. In some embodiments, the door can have a rigid frame and a mesh panel extending across an opening in the frame. The mesh can also have the benefit of preventing bugs, leaves or other debris from entering the home while still permitting airflow.

In some embodiments, the door 111 can have an edge which extends around the entire door 111. The perimeter of the door 111 can have a hinge 114 which can be connected to the front cover 109. The perimeter edge of the door 111 can have one or more ribs, the one or more ribs can provide the door with rigidity so that the door does not warp or bend after use or extreme weather conditions. In some embodiments, the door 111 can have a groove along the bottom edge of the door 111. Advantageously, this groove on the bottom edge of the door can be used to place a magnet or ferrous element to bias the door 111 to a closed position. In some embodiments, the groove can be on the right edge of the door 111 or on the left edge of the door 111.

Some embodiments of the habitat 100 can be configured to include a wireless communication element and a latch for remote operation of a door latching mechanism for the habitat 100. The wireless communication element can be capable of receiving instructions wirelessly from a user. A user can connect to the wireless communication element with an external device (e.g., phone, laptop, tablet) to send instructions to either latch or unlatch the door 111, remotely.

In some embodiments, the front cover 109 can have a handle or other grasping element that can be configured to assist the user in placing the front cover on the housing 102. The handle can be located on the top portion of the front cover 109. In other embodiments, the handle can be located on any side of the front cover 109 (e.g., top, left side, right side, bottom). Advantageously, the handle can be molded onto the front cover such the handle and the front cover are one solid piece. Alternatively, the handle can be an attachment which can be assembled onto the front cover 109 with fasteners or alternative engagement features.

In some embodiments, the front cover 109 can include support structures which provide increased rigidity to the front cover 109. These support structures might include ribs, gussets, chamfers, fillets, or other similar supporting structures to ensure that the front cover 109 can withstand stresses.

In some embodiments, the front cover 109 can include one or more ribs. The ribs can be located on the back side of the front cover 109. In some embodiments, the ribs can be vertical. The ribs can extend from the top of the front cover 109 to the bottom of the front cover 109. Alternatively, the ribs can partially extend from the top of the front cover 109 to the bottom of the front cover 109. In some embodiments, the ribs can be located adjacent to the opening 110 on the front cover 109. The ribs, in this embodiment, can provide increased rigidity to the front cover. In some embodiments, the ribs can provide increased rigidity when the animal opens the door 111 to pass through the opening 110.

In any embodiments disclosed herein, the front cover 109 can be made of or include mesh. In this arrangement, the mesh or mostly mesh front cover 109 can provide for air passage through the housing 102 and/or front cover 109, even when the front cover 109 is coupled with the housing 102 and when the door 111 is in the closed position. For example and without limitation, the front cover 109 can function similar to a screen door or a window screen. In this embodiment, the home can receive airflow when air passes through the housing 102, through the space 108 within the housing 102, and through the mesh of the front cover 109 and/or the door 111 coupled with the front cover 109, even when the front cover 109 is coupled with the housing 102 and the door 111 is closed. In some embodiments, the front cover 109 can have a rigid frame and a mesh panel extending across an opening in the frame. The mesh can also have the benefit of preventing bugs, leaves or other debris from entering the home while still permitting airflow.

In some embodiments, the front cover 109 can include engagement features for the ledge 112. The engagement features on the front cover can be for one or more snaps joints located along the bottom edge of the front cover 109. Alternatively, the engagement features on the front cover 109 can be for fasteners which require tooling to remove the ledge 112 from the front cover 109. The engagement features for the fasteners can be located adjacent to the bottom edge of the front cover 109. In some embodiments, there can be a plurality of engagement features for fasteners located adjacent to the bottom edge of the front cover 109.

In some embodiments, the front cover 109 can be designed to retain snap fit joints on the ledge 112 that extend from the rightmost edge of the front cover 109 to the leftmost edge of the front cover 109. The front cover 109 can have the retaining features for the snap joints located on the bottom edge of the front cover 109. The retaining feature for the snap fit joints can be to receive cantilever snap joints or torsion snap joints. The snap joints can have a tapered hook at the tip which engages the front cover 109. In some embodiments, the front cover 109 can have retaining features which can help bend the snap joints on the ledge 112 to couple the ledge 112 to the front cover 109. In some embodiments, the ledge 112 can be removably coupled to the front cover 109. In any embodiment, the ledge 112 can be removed by hand, without tooling from the front cover 109. In some embodiments, the front cover 109 can have one or more rows of retaining features which can be used to removably connect the ledge 112 to the front cover 109. The additional rows of retaining features can provide additional rigidity when an animal is on the ledge 112.

In some embodiments, the front cover 109 can have an indented surface. The indented surface on the front cover 109 can be around the opening 110. In another embodiment, the front cover 109 can have an indented surface between the outermost edges of the front cover 109 and the opening 110. Alternatively, the front cover 109 can be a flat surface. In some embodiments, the front cover 109 can have an outer frame. Additionally, the front cover 109 can be frosted or textured.

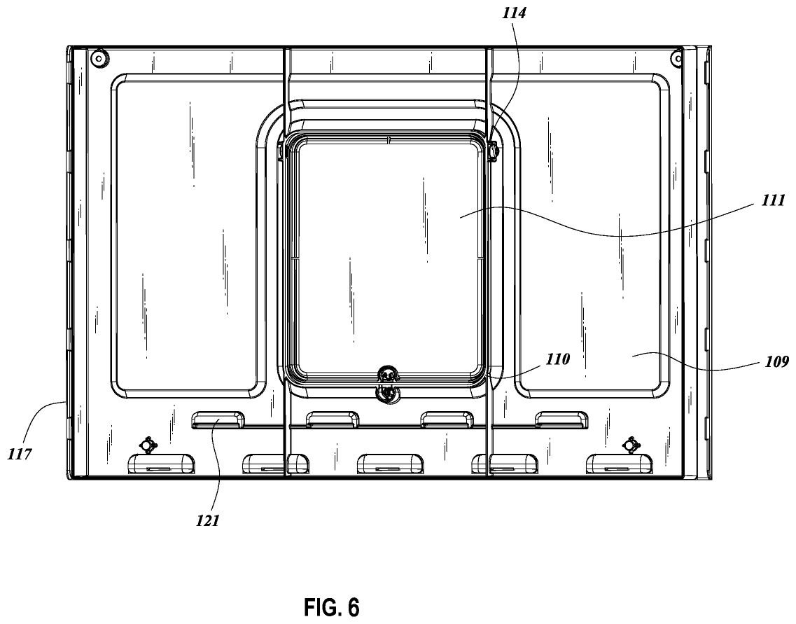

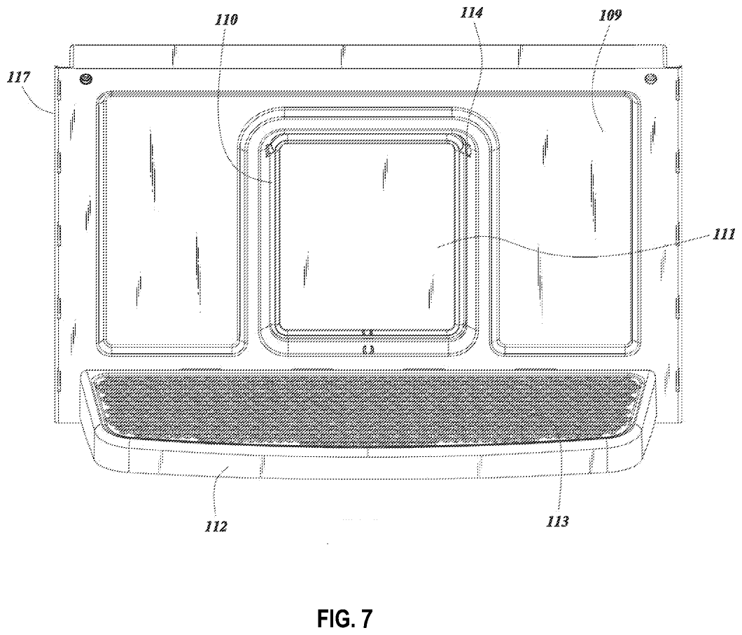

As shown in FIGS. 1-2 and 5-7, in some embodiments, the habitat 100 can have a ledge 112 that extends outwards from a lower portion of the front cover 109. The ledge 112 can be coupled with the front cover 109 in the lower portion of the front cover 109 and inferior to the opening and door on the front cover 109. The ledge 112 can be configured to permit the animal to have a place to stand, jump, or crawl since the door 111 located on the front cover 109 can be elevated from a lower surface. In some embodiments, the ledge 112 can include a plastic material (e.g., Polyethylene, Polypropylene, or Polyethylene Terephthalate). The ledge 112 can have a textured or bumpy surface 113 (e.g., raised domes, bumps, etching, abrasions, grass, or artificial turf) so that the animal has traction when it is walking or jumping on to the surface. Alternatively, the ledge 112 can have a smooth or generally smooth surface. In some embodiments, the ledge 112 can extend outwards from the front cover 109 at an angle, such as at an orthogonal angle.

In some embodiments, the ledge 112 can contain a magnet on its surface. Additionally, the door can contain a magnet. When the animal walks through the door, the magnet in the door will be biased by the magnet on the ledge 112 and will prevent the door from swinging.

In some embodiments, the ledge 112 can have a trapezoidal shape or a semi-circular shape. This ledge 112 shape can provide the animal with enough room to rest or perch without becoming cumbersome and occupying a significant amount of space in a home. In some embodiments, the ledge 112 can have edges, the edges of the ledge 112 can be rounded which can reduce the risk of injury to the animal or user when the ledge 112 is attached to the habitat 100 or when the ledge 112 is being connected to the habitat 100. In some embodiments, the ledge 112 can have a width dimension of at least 20″. Alternatively, the width of the ledge can be at least 12″, 13″, 14″ 15″, 16″, 17″, 18″, 19″, 21″, 22″, 23″, 24″, 25″, 26″, 27″, 28″, 29,″ or 30″. In some embodiments, the length of the ledge 112 can be at least 6″. Alternatively, the length of the ledge 112 can be at least 4″, 5″, 7″, 8″, 9″, 10″, 11″, 12″, 13″, 14″ 15″, 16″, 17″, 18″, 19″, 21″, 22″, 23″ or 24″.

In some embodiments, the ledge 112 can have one or more ribs which can provide additional rigidity and strength to the ledge 112 such that the ledge 112 can withstand the weigh of the animal perched or resting on the ledge 112. The ribs can fully extend from a rear portion of the ledge 112 to a front portion of the ledge 112. The ribs can fully extend from a left portion of the ledge 112 to a right portion of the ledge 112. Additionally, the ribs, in some embodiments, can partially extend from a rear edge of ledge 112 to a front edge of the ledge 112 or from a left edge of the ledge 112 to a right edge of the ledge 112.

In some embodiments, the ledge 112 can be removable from front cover 109. Functionally, this allows the ledge 112 to be replaced with another alternative ledge 112 which might have a different surface or geometry than the other ledge 112. In some embodiments, the ledge 112 can include engagement features 121 such as a snap fit, which permits the ledge 112 to be assembled without tooling. The ledge 112 can include a plurality of snap features along the edge meant to interact with the front cover 109. There can be a plurality of receiving features on the front cover 109 to receive the ledge 112.

In some embodiments, ledge 112 can have snap fit joints that can extend from the rightmost edge of the ledge 112 to the leftmost edge of the ledge 112. The front cover 109 can have the retaining features for the snap joints located on the bottom edge of the front cover 109. The snap fit joints on the ledge 112 can be cantilever snap joints or torsion snap joints. The snap joints can have a tapered hook at the tip which engages can engage the front cover 109. In some embodiments, the ledge 112 can be removably coupled to the front cover 109. In any embodiment, the ledge 112 can be removed by hand, without tooling from the front cover 109. In some embodiments, the front cover 109 can have one or more rows of retaining features which can be used to removably connect the ledge 112 to the front cover 109. The additional rows of retaining features can provide additional rigidity when an animal is on the ledge 112. In some embodiments, the ledge 112 can have slots or engagement features which can be used to couple the ledge 112 to the front cover 109. These slots or engagement features can be for any fastener or any fastener which requires tooling (e.g., screws, bolts, clamps, rivets, pins, clips, or any suitable fastening device).

In some embodiments, the ledge 112 can be attached directly to the housing 102. In this configuration, the ledge 112 can be attached to the housing 102 when the front cover 109 is removed from the housing 102 so as to be usable even when the front cover 109 is detached from the housing 102. In some embodiments, the housing 102 can include engagement features such as a snap fit to connect the ledge 112 to the housing 102. The housing 102 can have a plurality of receiving features to receive the ledge 112. In any embodiments disclosed herein, the habitat 100 can be configured such that the ledge 112 and/or the front cover 109 can be removed from the housing 102 and/or attached to the housing 102 by hand. Advantageously, this can prevent a person from having to use tools to remove the ledge 112, making the process of removing and replacing the front cover 109 and/or ledge 112 quicker and easier. In other embodiments, the ledge 112 can be coupled to the housing 102 such that a person cannot remove the ledge from the front cover with their hands. The ledge 112 can be attached to the housing 102 by fasteners which require tool to remove the ledge 112 from the housing 102.

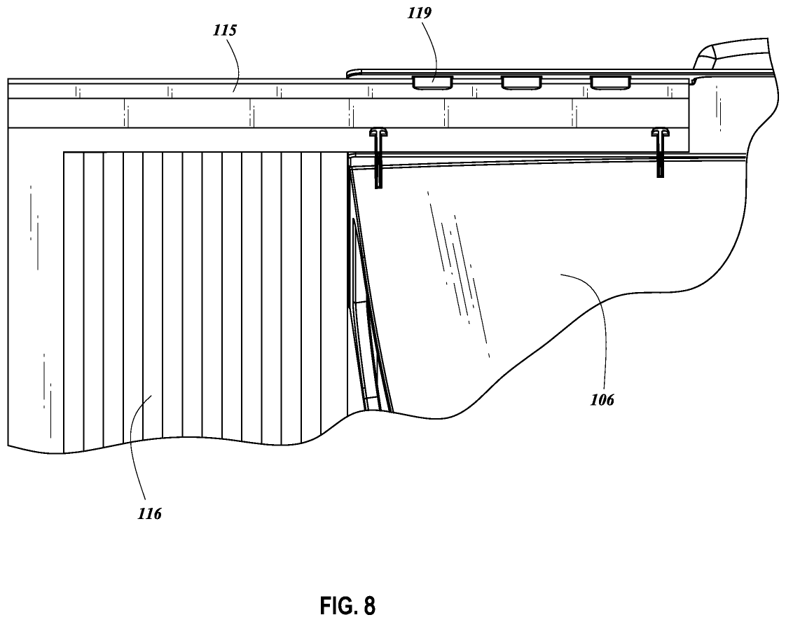

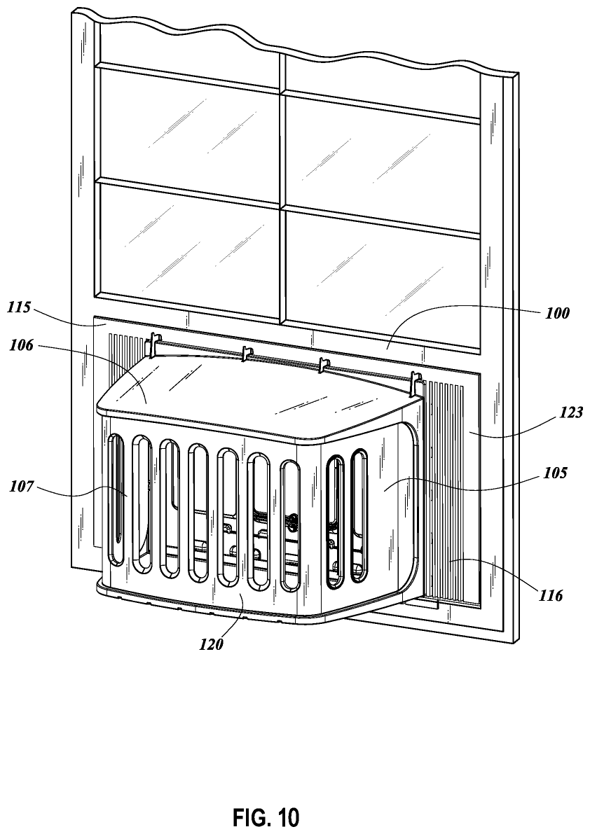

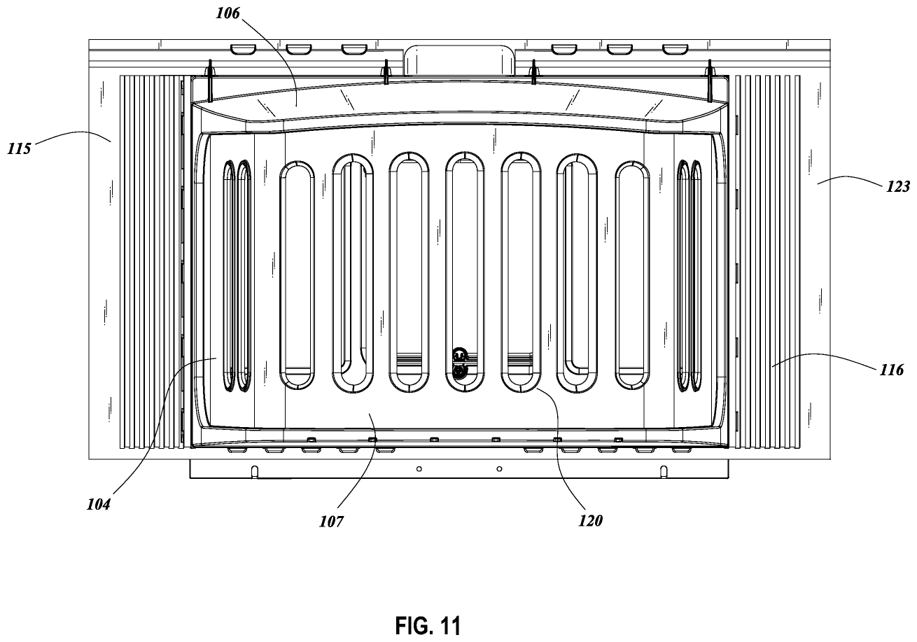

In FIGS. 1 and 8-11, in some embodiments there can be a first sealing panel 115 and/or a second sealing panel 123 that can be operably connected to the housing 102 of the habitat 100 and extend laterally from the habitat 100. Some embodiments of the habitat 100 can include a first sealing panel 115 and a second sealing panel 123. The first sealing panel 115 and the second sealing panel 123 can occupy the remaining open space in the window area when the scaling panels 115 extend laterally away from the housing 102 and, for example and without limitation, toward the sides of the window frame. In some embodiments, the habitat 100 which can include a first sealing panel and a second sealing panel 123 can be designed to fit a vertical window design. The vertical window can be a width of at least 24″ or in other embodiments, the width of the vertical window can be at least 18″, 30″, 36″, 48″, or 60″. The first sealing panel 115 and second sealing panel 123 can include a bellows component 116. In some embodiments, the bellows 116 can be flexible and can extend from the housing 102. The sealing panel 115 in some embodiments can be configured to fit into the open space of the window and fit into grooves or openings that the window has, based on the type and size of the window. In other embodiments, the sealing panel 115 can be configured to extend from the housing 102 to the end of the window opening and be coupled to the window with fasteners. The first sealing panel 115 and a second scaling panel 123 can include apertures which permit a fastener to couple a first sealing panel 15 and a second sealing panel 123 to the window which can keep the habitat 100 in place and prevents the habitat 100 from falling out of the window. By attaching a first sealing panel 115 and a second scaling panel 123 to the window, in some embodiments, the window will no longer be open to the external elements (e.g., wind, snow, rain, sleet, heat) and the window can function as though it is closed.

In some embodiments, the first sealing panel 115 and a second sealing panel 123 can engage with the housing via engagement features 119 which secure the first sealing panel 115 and the second sealing panel 123 and bellows 116 to the housing 102. These engagement features 119 features can include hook features which extend over the first scaling panel 115 and a second sealing panel 123. Functionally, these hook features allow a first sealing panel 115 and a second sealing panel 123 to easily slide on the housing 102. In another embodiment, the engagement features 119 can be snap like features, which have a tolerance fit permitting the housing 102 to securely engage a first sealing panel 115 and a second sealing panel 123. When pressure is applied, the engagement features 119 can be configured to bend/flex allowing a first sealing panel 115 and a second sealing panel 123 to be removed.

As shown in FIG. 14, the habitat 100 can have one or more clamps coupled with or coupleable with the housing 102. For example, in some embodiments, the one or more clamps can be coupled with a front portion of the housing 102. The one or more clamps can include a first clamp 131 and a second clamp 134. The first clamp 131 can have a first knob 132 coupled with a first threaded rod 133 threadably engaged with a first body portion 137. The second clamp 134 can have a second knob 135 coupled with a second threaded rod 136 threadably engaged with a second body portion 142. The first clamp 131 and the second clamp 134 can be positioned to engage a window unit to secure the habitat 100 to the window. The knobs can extend away from the front portion of the housing to give a user access to the knobs. The first body portion 137 and the second body portion 142 can each have an opening, where the openings can allow the first threaded rod 133 and the second threaded rod 136 to pass through the openings to close or open the first clamp 131 and the second clamp 134. In some embodiments, the first body portion 137 and the second body portion 142 can be c-shaped or alternatively shaped (e.g., Z-shaped, U-shaped, etc.) to securely couple the habitat 100 to the window (e.g., bar clamp, bench clamp, hand screw clamp, spring clamp, etc.).

In some embodiments, the first clamp 131 and the second clamp 134 can be positioned above the front cover 109. For example and without limitation, the first clamp 131 can be located on or near a top rightmost edge of the front cover 109 or on or near a top leftmost edge of the front cover 109. The first clamp 131 can be located above a top leftmost edge or top rightmost edge of the front cover 109. The second clamp 134 can be located on or near a top rightmost edge of the front cover 109 or on or near a top leftmost edge of the front cover 109. The second clamp 134 can be located above a top rightmost edge of the front cover 109. Advantageously, the first clamp 131 and the second clamp 134 can have similar, if not identical functionality. In some embodiments, the first clamp 131 can be positioned in front of the habitat 100 on a corner adjacent to the upper portion 106 of the housing 102 and the first side portion 104 of the housing 102. Additionally, in some embodiments, the second clamp 134 can be positioned in front of the habitat 100 on a corner adjacent to the upper portion 106 of the housing 102 and the second side portion 105 of the housing 102.

In some embodiments, when the habitat 100 is positioned in a window, the first clamp 131 and the second clamp 134 can secure the habitat 100 to the window by rotating the first knob 132 and the second knob 135, respectively. The habitat 100 can, in some embodiments, be configured such that rotating the knobs in a first direction can cause the threaded rods of each clamp to thread into the body portions of each clamp to thereby cause the body portions of each clamp to move toward the front portion of the housing and a window frame positioned between a flange of the housing and the body portion of each clamp, thereby securing the habitat 100 to a window. Thus, rotating the first knob 132 which can be coupled to the first clamp 131 in a first direction can place the first clamp 131 in a locked position, which can translate the first body portion 137 along a first direction, which can close the first clamp 131 and can secure the habitat 100 to a window. In some embodiments, the first body portion 137 can translate along the first threaded rod 133. Additionally, in some embodiments, the first body portion 137 can translate along the first threaded rod 133 without rotating about an axis of the first threaded rod 133. In some embodiments, the first direction can be a direction towards a window. Additionally, the first body portion 137 can translate along a first rail or pair of rails 150 (also referred to herein as guides or channels). The first set of rails 150 can be located on a top edge of the upper portion 106. The first body portion 137 can have one or more channels (e.g., two channels) which can operably allow the first body portion 137 to translate along the first set of rails 150. In some embodiments, the first set of rails 150 can inhibit (e.g., prevent) the first body portion 137 from rotating as the first body portion 137 translates along the first threaded rod 133. Additionally, rotating the first knob 132 on the first clamp 131 in a second direction (i.e., opposite the first direction) can open the first clamp 131 to an open or unlocked position, where the first body portion 137 translates along a second direction which is opposite the first direction. In some embodiments, the second direction can be a direction away from the window.

In some embodiments, rotating the second knob 135 which can be coupled to the second clamp 134 in a first direction can place the second clamp 134 in a locked position, which can translate the second body portion 142 along a first direction, which can close the second clamp 134 and can secure the habitat 100 to a window. In some embodiments, the second body portion 142 can translate along the second threaded rod 136. Additionally, in some embodiments, the second body portion 142 can translate along the second threaded rod 136 without rotating about an axis of the second threaded rod 136.

The second body portion 142 can translate along a second rail or pair of rails 152. Advantageously, the second rail or pair of rails 152 can be located on a top edge of the upper portion 106. The second set of rails 152 for the second body portion 142 can be located opposite the first rail or pair of rails 150 for the first body portion 137. The second body portion 142 can have a channel which can operably allow the second body portion 142 to translate along the second set of rails 152. Advantageously, the second set of rails 152 can prevent the second body portion 142 from rotating as the second body portion 142 translates along the second threaded rod 136. Additionally, rotating the second knob 135 on the second clamp 134 in a second direction can open the second clamp 134 to an open or unlocked position. Advantageously, the first clamp 131 and the second clamp 134 can allow the habitat 100 to be secured to the window without the use of fasteners or, in some embodiments, without the use of any fasteners that are driven or advanced into any portion of the window or window frame. The use of the term window herein is to be understood to include the window frame. The first clamp 131 and the second clamp can permit the habitat 100 to be easily installed and/or removed from a window unit without the need of tools.

In some embodiments, the first knob 132 can be coupled to the first threaded rod 133. Functionally, in some embodiments, when the first knob 132 is rotated in a first direction, the first threaded rod 133 can rotate to close the first clamp 131 to position the first clamp 131 in a locked or closed position. In some embodiments, the first clamp 131 can have a texture or a gripping material (such as rubber) on a front surface, where the texture can allow the first clamp 131 to engage (i.e., grip) the window and prevent the first clamp 131 from slipping. In some embodiments, the front surface can be positioned on the first body portion 137. The front surface can have a wide profile which can operably allow the first clamp 131 to be secured to the window. The first body portion 137 can have a width between 0.75 inches and approximately 3 inches. Functionally, in some embodiments, when the second knob 135 is rotated in a first direction, the second threaded rod 136 can rotate to close the second clamp 134 to position the second clamp 134 in a locked or closed position. In some embodiments, the second clamp 134 can have a texture or a gripping material (such as rubber) on a front surface, where the texture can allow the second clamp 134 to engage the window without slipping. In some embodiments, the front surface can be positioned on the second body portion 142. The front surface can have a wide profile which can operably allow the second clamp 134 to be secured to the window. The second body portion 142 can have a width between 0.75 inches and approximately 3 inches.

Additionally, in some embodiments, the first threaded rod 133 and the second threaded rod 136 can be 0.7 to 0.75 inches. The size of the first threaded rod 133 and the second threaded rod 136 can advantageously allow the first clamp 131 and second clamp 134 to secure the habitat 100 to variety of different windows of various sizes. In any embodiment disclosed herein, the first knob 132 of the first clamp 131 can be biased to not rotate unless a user rotates the first knob 132 in a first direction or a second direction, which can allow the first clamp 131 to secure the habitat 100 to the window and can prevent the first clamp 131 from rotating without user intervention. In some embodiments, the bottom portion 103 of the housing 102 is secured to the window, where the window has a horizontal window tract. Advantageously, this can allow the bottom portion 103 of the housing 102 to not require one or more clamps.

In some embodiments, when the habitat 100 is positioned in a window, the first clamp 131 and the second clamp 134 can secure the habitat 100 to the window by rotating the first clamp 131 and the second clamp 134 from a stowed position to a deployed position. For example and without limitation, the stowed position can be when the first body portion 137 and the second body portion 142 are positioned in a horizontal (e.g., 90 degree) orientation which can be below a bottom portion of a vertical sliding window. Additionally, the deployed position can be when the first body portion 137 and the second body portion 142 are positioned in a vertical (e.g., 180 degree) orientation which can extend above a bottom portion of a vertical sliding window. Therefore, in some embodiments, when the habitat 100 is positioned in the window unit, the first body portion 137 and the second body portion 142 can be placed in the stowed position from the deployed position to secure the habitat 100 in the window unit by rotating the first knob 132 and the second knob 135 in a first direction and can be placed in the deployed position to the stowed position by rotating the first knob 132 and the second knob 135 in a second direction. In some embodiments, the first body portion 137 and second body portion 142 can be configured to translate towards a window unit and rotate to the deployed position by rotating the first knob 132 and second knob 135 in a first direction or first path. Additionally, the first body portion 137 and the second body portion 142 can be configured to translate away from a window unit and rotate to the stowed position by rotating the first knob 132 and the second knob 135 in a second direction or second path. In some embodiments, the first body portion 137 and second body portion 142 are coupled to the first threaded rod 133 and second threaded rod 136, respectively.

In any embodiments disclosed herein, the animal habitat 100 can have one or more cat toys, bells, bowls, or other objects inside the housing, either loosely positioned or coupled with the inside of the housing. In some embodiments, the animal habitat 100 can have a litter box inside the housing. Additionally, in any embodiments disclosed herein, the animal habitat can have an integral or connected planter or flower box on the outside thereof that the user can use to make the device more aesthetically appealing from the outside or to grow catnip or otherwise. The planter can be positioned adjacent to the back or the side surfaces of the outside of the housing.

As shown in FIG. 15, some embodiments of the animal habitat 100 can include a litter box 140 positionable within the space 108 within the housing 102. The litter box 140 can be dimensioned such that an animal or cat can easily enter the space 108 within the housing 102 and/or enter the litter box 140 by passing through the front of the housing. In some embodiments the litter box 140 can have a front wall, where the front wall can have a U-shaped cutout. The U-shaped cutout can allow the animal to pass through the door 111 to sit or perch in the litter box 140 when the front cover is in a closed position on the housing. The litter box 140 can have a U-shaped cutout which can be dimensioned to allow the door 111 to fully swing within the U-shaped opening and into the space 108 within the housing 102. In some embodiments, the litter box 140 can have a width (e.g., distance from the first side portion 104 to the second side portion 105) that is 19.125 inches or approximately 19 inches. However, in some embodiments, the width can be from 12 inches to 30 inches. In some embodiments, the litter box 140 can have a depth (e.g., distance from the back portion 107 to the front cover 109 when closed) of 11.53 inches. However, in some embodiments, the depth can be from 6 inches and 15 inches. In any embodiments disclosed herein, the litter box can be sized and configured to cover all or substantially all (e.g., 90% or more) of the bottom portion 103 of the housing.

In some embodiments, the litter box 140 can have a height of 5 inches. However, in some embodiments, the height of the litter box 140 can be between 1 and 7 inches. The height of a base of the U-shaped portion of the litter box 140 can be shorter than the total height of the litter box 140. In some embodiments the U-shaped portion can be configured to have a width approximately equal to the width of the door 111.

In some embodiments, the litter box 140 can be coupled and/or can rest on the bottom portion 103 of the housing. In some embodiments, the litter box 140 can include one or more engagement features or coupling features which can secure the litter box 140 to the bottom portion 103. The one or more engagement features can be snaps, snap fittings, fasteners, slides, or slide fittings which can couple the litter box 140 to the bottom portion 103. In some embodiments, the bottom portion 103 can include identical or complementary engagement or coupling features to attach the litter box 140 to the bottom portion.

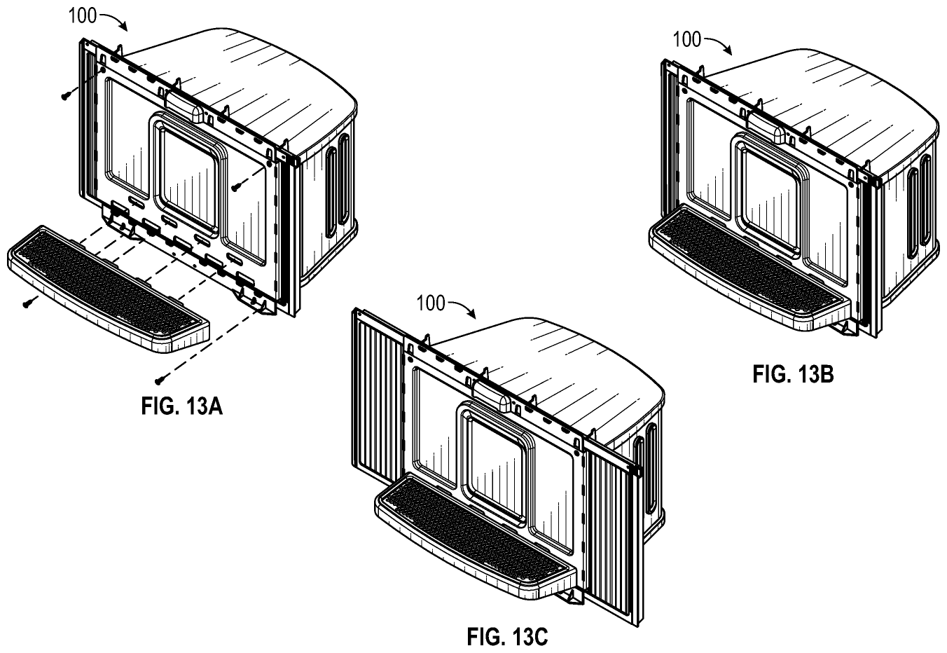

As shown in FIGS. 13A-13C, the animal habitat 100 can be coupled to a ledge 112. The ledge 112 can extend outwards from a lower portion of the front cover 109. The ledge 112 can be coupled with the front cover 109 in the lower portion of the front cover 109 and inferior to the opening and door 111 on the front cover 109. Additionally, the ledge can be positioned on a lower front portion of the housing which can receive the ledge 112. The ledge 112 can be configured to permit the animal to have a place to stand, jump, or crawl since the door located on the front cover 109 can be elevated from a lower surface. The ledge 112 can include engagement features 121 such as a snap fit, which permits the ledge 112 to be assembled without tooling. The ledge 112 can include a plurality of snap features along an edge meant to interact with the front cover 109. Additionally, in some embodiments, the ledge 112 can include snap features for engaging with the lower front portion of the housing 102. There can be a plurality of receiving features on the lower front portion of the housing 102 to receive the ledge 112 which can allow the ledge to couple with the habitat 100. Additionally, the habitat 100 can have a first scaling panel 115 and a second sealing panel 123, where the first sealing panel 115 and the second sealing panel 123 can extend in a direction away from the housing 102.

As shown in FIGS. 13D-13G, the animal habitat 100 can be positioned in a vertical sliding window. The habitat 100 can be positioned in the window by positioning the bottom portion 103 of the housing 102 on a bottom portion of the window frame. The bottom portion of the window can be secured to the bottom portion 103 of the housing 102 via an engagement feature which can removably couple the bottom portion 103 and the window. Furthermore, in some embodiments, the first side portion 104 and second side portion 105 can be positioned to be partially within a window frame. In some embodiments, the habitat 100 can have a first sealing panel 115 and a second sealing panel 123. The first sealing panel 115 and the second sealing panel 123 can occupy open space in the window area. The first sealing panel 115 can extend laterally away from the housing 102 and into a side of the window frame (e.g., first side portion of the window frame). The second sealing panel 123 can extend laterally away from the housing into a side of the window frame (e.g., second side portion of the window frame). In some embodiments, the first sealing panel 115 and the second sealing panel 123 can be co-planar with the window frame.

In some embodiments disclosed herein, the upper portion 106 of the housing 102 can be positioned to engage a bottom portion of the sliding window. The upper portion 106 of the sliding window can couple with engagement features on the upper portion 106 of the of the housing 102. In some embodiments, as described, the habitat 100 can have one or more clamps. The one or more clamps, in some embodiments, can include a first clamp 131 and a second clamp 134. The first clamp 131 and the second clamp 134 can couple the habitat 100 to the vertical sliding window to secure the habitat 100 within the window frame. In some embodiments, when the first clamp 131 and the second clamp 134 have a first knob 132 and a second knob 135, respectively, rotating the first knob 132 and the second knob 135 in a first direction when the vertical sliding portion of the window is positioned within the first clamp 131 and the second clamp 134 can secure the habitat 100 to the window.

Therefore, in some embodiments, when a user slides the vertical window down to engage the upper portion 106 of the housing 102, the first clamp 131 and the second clamp 134 can operably engage the vertical sliding portion of the window and can secure the habitat 100. Advantageously, securing the habitat 100 can prevent the animal within some embodiments of the habitat 100 or some embodiments of the habitat 100 from falling from the window. In some embodiments, when the user slides the vertical window down to engage the upper portion 106 of the housing 102, the housing 102 can be removably coupled to the window via fasteners. In some embodiments, the habitat can be coupled to the vertical sliding window with both fasteners and the first clamp 131 and second clamp 134. In some embodiments, a significant portion of the housing can be positioned in a region external to the window.

While certain arrangements of the inventions have been described, these arrangements have been presented by way of example only, and are not intended to limit the scope of the disclosure. Indeed, the novel methods and systems described herein can be embodied in a variety of other forms. Furthermore, various omissions, substitutions and changes in the systems and methods described herein can be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, arrangement, or example are to be understood to be applicable to any other aspect, arrangement or example described in this section or elsewhere in this specification unless incompatible therewith. All of the features disclosed in this specification (including any accompanying claims, abstract and drawings), and/or all of the steps of any method or process so disclosed, can be combined in any combination, except combinations where at least some of such features and/or steps are mutually exclusive. The protection is not restricted to the details of any foregoing arrangements. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations, one or more features from a claimed combination can, in some cases, be excised from the combination, and the combination can be claimed as a subcombination or variation of a subcombination.

Moreover, while operations can be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations can be rearranged or reordered in other embodiments. Those skilled in the art will appreciate that in some arrangements, the actual steps taken in the processes illustrated and/or disclosed may differ from those shown in the figures. Depending on the arrangement, certain of the steps described above can be removed, others can be added. Furthermore, the features and attributes of the specific arrangements disclosed above can be combined in different ways to form additional arrangements, all of which fall within the scope of the present disclosure. Also, the separation of various system components in the embodiments described above should not be understood as requiring such separation in all embodiments, and it should be understood that the described components and systems can generally be integrated together in a single product or packaged into multiple products.

For purposes of this disclosure, certain aspects, advantages, and novel features are described herein. Not necessarily all such advantages can be achieved in accordance with any particular arrangement. Thus, for example, those skilled in the art will recognize that the disclosure can be embodied or carried out in a manner that achieves one advantage or a group of advantages as taught herein without necessarily achieving other advantages as can be taught or suggested herein.

Conditional language, such as “can,” “could,” “might,” or “may,” unless specifically stated otherwise, or otherwise understood within the context as used, is generally intended to convey that certain arrangements include, while other arrangements do not include, certain features, elements, and/or steps. Thus, such conditional language is not generally intended to imply that features, elements, and/or steps are in any way required for one or more arrangements or that one or more arrangements necessarily include logic for deciding, with or without user input or prompting, whether these features, elements, and/or steps are included or are to be performed in any particular arrangement.

Conjunctive language such as the phrase “at least one of X, Y, and Z,” unless specifically stated otherwise, is otherwise understood with the context as used in general to convey that an item, term, etc. can be either X, Y, or Z. Thus, such conjunctive language is not generally intended to imply that certain arrangements require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain arrangements, the terms “generally parallel” and “substantially parallel” refer to a value, amount, or characteristic that departs from exactly parallel by less than or equal to 15°, 10°, 5°, 3°, 1 degree, or 0.1 degree. The ranges disclosed herein also encompass any and all overlap, sub-ranges, and combinations thereof, and any specific values within those ranges. Language such as “up to,” “at least,” “greater than,” “less than,” “between,” and the like includes the number recited. Numbers and values used herein preceded by a term such as “about” or “approximately” include the recited numbers. For example, “approximately 7 mm” includes “7 mm” and numbers and ranges preceded by a term such as “about” or “approximately” should be interpreted as disclosing numbers and ranges with or without such a term in front of the number or value such that this application supports claiming the numbers, values and ranges disclosed in the specification and/or claims with or without the term such as “about” or “approximately” before such numbers, values or ranges such, for example, that “approximately two times to approximately five times” also includes the disclosure of the range of “two times to five times.” The scope of the present disclosure is not intended to be limited by the specific disclosures of preferred arrangements in this section or elsewhere in this specification, and can be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An animal habitat for positioning in a window opening, comprising:
a housing, the housing comprising:
a bottom portion;
a first side portion coupled with the bottom portion;
a second side portion coupled with the bottom portion;
an upper portion coupled with the first side portion and the second side portion;
a back portion coupled with the bottom portion, the first side portion, and the second side portion;
a space within the housing, the space bounded at least by the bottom portion, the first side portion, the second side portion, and the upper portion; and
an opening in communication with the space within the housing;
a front cover configured to be coupled with the housing and to cover the opening in the housing when the front cover is coupled with the housing, the front cover comprising:
an opening sized and configured to permit an animal to pass therethrough and into the space within the housing when the front cover is operably coupled with the housing; and
a door configured to move between an open position and a closed position relative to the opening;
a ledge extending outward away from the front cover below the opening in the front cover, the ledge being sized and configured to permit an animal to be supported by the ledge outside of the space within the housing; and
a clamp configured to engage with a portion of a window frame surrounding the window opening or to a window configured to slide relative to the window frame.

2. The habitat of claim 1, wherein the clamp includes a knob positioned on a front portion of the housing, the knob being configured to rotate in a first direction to operatively close the clamp to secure the habitat in the window opening, the knob being configured to rotate in a second direction to operatively open the clamp.

3. The habitat of claim 1, wherein the opening in the housing extends entirely across a front of the housing and the front cover is configured to extend across the entire opening in the housing when the front cover is coupled with the housing.

4. The habitat of claim 1, wherein the front cover comprises a grasping element located in a top portion of the front cover, the grasping element being configured to permit a user to engage the grasping element with one or both hands and lift at least the front cover with one or both hands.

5. The habitat of claim 1, wherein the door is biased to the closed position using one or more magnets.

6. The habitat of claim 1, wherein the door is biased to the closed position using at least one magnet coupled with the housing or the door and at least one ferrous element or a magnet coupled with the other of the housing and the door.

7. The habitat of claim 1, wherein the housing is monolithically formed such that the bottom portion, the first side portion, the second side portion, the upper portion, and the back portion are a formed as a single component.

8. The habitat of claim 1, wherein the bottom portion of the housing is textured with carpet, domes, grass, artificial turf, or raised bumps.

9. The habitat of claim 1, wherein the back portion of the housing comprises openings or slots.

10. The habitat of claim 1, wherein the back portion of the housing comprises a plurality of slots, the plurality of slots having a mesh covering.

11. The habitat of claim 10, wherein the plurality of slots have a height in a vertical direction that is less than or equal to 90% of a total height of the back portion in a vertical direction.

12. The habitat of claim 1, wherein the upper portion is sloped to operably bias water to drain from the upper portion.

13. The habitat of claim 1, further comprising a first sealing panel and a second sealing panel configured to extend laterally away from the first side portion and second side portion of the housing in a first direction and a second direction, respectively, to fit in an open space of a vertical window, wherein the second direction is opposite to the first direction, wherein the first sealing panel and second sealing panel each comprise a flexible bellows component and a plastic frame.

14. The habitat of claim 1, further comprising a litter box configured to be positioned within the space within the housing.

15. The habitat of claim 1, wherein the front cover comprises one or more tabs having a body portion projecting in direction away from a front face of the housing, wherein the one or more tabs are configured to removably couple the front cover to the housing.

16. The habitat of claim 15 wherein releasing the one or more tabs permits the one or more tabs to be released from one or more receptacles of the housing, wherein releasing the one or more tabs permits the front cover to be rotated away from the housing via a horizontal hinge to permit additional access to a space inside the housing.

17. The habitat of claim 1, wherein the front cover is coupled to a horizontal hinge, the horizontal hinge being positioned at a bottom of the front cover or in a bottom portion of the front cover to expose the opening of the housing.

18. The habitat of claim 2, wherein:
the clamp includes a body portion and a threaded rod;
the body portion is threadably engaged with the threaded rod;
the clamp is configured such that rotating the knob of the clamp in a first direction translates the body portion along the threaded rod towards an upper front portion of the habitat to close the clamp; and
rotating the knob of the clamp in a second direction translates the body portion along the threaded rod away from the upper front portion of the habitat to open the clamp.

19. A method for positioning an animal habitat in a window, comprising:
positioning a housing comprising a bottom portion, a first side portion coupled with the bottom portion, a second side portion coupled with the bottom portion, an upper portion coupled with the first side portion and the second side portion, a back portion coupled with the bottom portion into an opening within a window frame;
advancing at least the back portion of the housing through the opening in the window frame;
positioning the bottom portion of the housing on a bottom portion of the window frame;
sliding a first sealing panel coupled to the housing toward a first side portion of the window frame;
sliding a second sealing panel coupled to the housing toward a second side portion of the window frame; and
clamping the housing to a lower portion of a window of the window frame.

20. The method of claim 19, wherein the clamp includes two clamps spaced apart along the upper portion of the housing.

21. The method of claim 19, wherein the clamp translates along a rail to secure the housing to the window.

22. The method of claim 19, wherein the clamp is translated in a first direction by rotating a knob along a first path to clamp the housing to the window, the clamp is translated in a second direction by rotating a knob along a second path to release the housing from the window.

23. The method of claim 19, further comprising sliding a vertical sliding portion of the window downward to a position adjacent to the upper portion of the housing before clamping the housing to a lower portion of the window.

24. The method of claim 19, wherein clamping the housing to the lower portion of the window of the window frame comprises rotating a threaded rod that passes through a front portion of the housing into a clamp body to tighten the clamp body against the lower portion of the window.
